(19) United States
(12) Patent Application Publication
(10) Pub. No.: US 2017/0374473 A1
(43) Pub. Date: Dec. 28, 2017

(54) MEMS TRANSDUCER PACKAGE

(71) Applicant: Cirrus Logic International Semiconductor Ltd., Edinburgh (GB)

(72) Inventors: Tsjerk HOEKSTRA, Balerno (GB); David Talmage PATTEN, Austin, TX (US)

(73) Assignee: Cirrus Logic International Semiconductor Ltd., Edinburgh (GB)

(21) Appl. No.: 15/538,598

(22) PCT Filed: Dec. 4, 2015
(86) PCT No.: PCT/GB2015/053726

§ 371 Date: Jun. 21, 2017

Related U.S. Application Data
(60) Provisional application No. 62/096,445, filed on Dec. 23, 2014.

(51) Int. Cl. H04R 19/00; H04R 19/04; H04R 31/00; H04R 1/38

(52) U.S. Cl. CPC H04R 19/005; H04R 2410/07; H04R 1/38; H04R 19/04; H04R 31/00

(57) ABSTRACT

A method of fabricating a micro-electrical-mechanical system (MEMS) transducer chip scale package. The method comprising: providing (101) a front side pre-fabricated semiconductor die wafer (1) comprising a plurality of individual die that each comprise at least a MEMS transducer. And back etching (104) the semiconductor die wafer (1) at the back side (4) of the semiconductor die wafer (1) by etching an acoustic die channel (5) through each respective die of the plurality of die and etching a die back volume (6) into each respective die of the plurality of die. The semiconductor die wafer (1) is capped with a cap wafer (16) such that a wafer level packaged MEMS transducer wafer is provided containing multiple MEMS transducer chip scale packages.

### TECHNICAL FIELD

The present application relates to a method of manufacturing a Micro-electromechanical-system (MEMS) transducer and transducer package, for example a MEMS microphone transducer and transducer package (including a Capacitive-type MEMS transducer, a Piezo-type MEMS transducer, or an Optical-type microphone), and to a semiconductor die portion and cap portion for use in a MEMS transducer package.

### BACKGROUND

Consumer electronics devices are continually getting smaller and, with advances in technology, are gaining ever-increasing performance and functionality. This is clearly evident in the technology used in consumer electronic products and especially, but not exclusively, portable products such as mobile phones, audio players, video players, personal digital assistants (PDAs), various wearable devices, mobile computing platforms such as laptop computers or tablets and/or games devices. Requirements of the mobile phone industry for example, are driving the components to become smaller with higher functionality and reduced cost. It is therefore desirable to integrate functions of electronic circuits together and combine them with transducer devices such as microphones and speakers.

Micro-electromechanical-system (MEMS) transducers, such as MEMS microphones are finding application in many of these devices. There is therefore also a continual drive to reduce the size and cost of the MEMS devices.

Microphone devices formed using MEMS fabrication processes typically comprise one or more membranes with electrodes for read-out/drive that are deposited on or within the membranes and/or a substrate or back-plate. In the case of MEMS pressure sensors and microphones, the electrical output signal read-out is usually accomplished by measuring a signal related to the capacitance between the electrodes. However in some cases the output signal may be derived by monitoring piezo-resistive or piezo-electric elements. In the case of capacitive output transducers, the membrane is moved by electrostatic forces generated by varying a potential difference applied across the electrodes, though in some other output transducers piezo-electric elements may be manufactured using MEMS techniques and electrically stimulated to cause motion in flexible members.

To provide protection, the MEMS transducer element will be contained within a package. The package effectively encloses the MEMS transducer element and can provide environmental protection while permitting the physical input signal to access the transducer element and providing external connections for the electrical output signal. The size and dimensions of the package containing the MEMS transducer element determine the overall size of the microphone device. Various other styles of packages for MEMS microphone and other MEMS transducers are available, but may be complex multi-part assemblies and/or require physical clearance around the transducer for connections, impacting material and manufacturing cost and physical size.

### SUMMARY

It is an aim of the present invention to provide a method and apparatus which obviate or reduce at least one or more of the disadvantages mentioned above. According to a first aspect of the present invention, there is provided a method of fabricating a micro-electrical-mechanical system (MEMS) transducer chip scale package, the method comprising providing a front side pre-fabricated semiconductor die wafer comprising a plurality of individual die that each comprise at least a MEMS transducer, and back etching the semiconductor die wafer; wherein the back etching comprises, at the back side of the semiconductor die wafer etching an acoustic die channel through each respective die of the plurality of die and etching a die back volume into each respective die of the plurality of die.

### BRIEF DESCRIPTION OF DRAWINGS

For a better understanding of the present invention, and to show how it may be put into effect, reference will now be made, by way of example, to the accompanying drawings, in which:

FIG. 1 illustrates a process flow of a method of preparing a semiconductor die wafer;

FIG. 2 shows a cross-section of an example of a semiconductor die being part of the semiconductor die wafer obtained by the process of FIG. 1;

FIG. 3 illustrates a method of additional processing of the semiconductor die wafer of FIG. 1;

FIG. 4 illustrates a method of additional processing of the semiconductor die wafer of FIG. 3;

FIGS. 5A & 5B illustrate two embodiments of a method of fabricating a MEMS transducer package;

FIG. 6 shows an intermediate result of the process according to FIG. 4;

FIG. 7 shows a consecutive result of the process according to FIG. 4;

FIG. 8 shows a consecutive result of the process according to FIG. 4;

FIG. 9 shows a consecutive result of the process according to FIG. 4;

FIG. 10 shows a consecutive result of the process according to FIG. 4;

FIG. 11 shows a consecutive result of the process according to FIG. 4;

FIG. 12 shows a consecutive result of the process according to FIG. 4;

FIG. 13 shows another result of the process according to FIG. 4;

FIG. 14 shows a cap in cross-section of an intermediate result of a process of preparing a front side pre-fabricated cap wafer;

FIG. 15 shows a consecutive result of processing the cap wafer of FIG. 14;

FIG. 16 shows a consecutive result of processing the cap wafer of FIG. 15;

FIG. 17 shows a consecutive result of processing the cap wafer of FIG. 16;

FIG. 18 shows a consecutive result of processing the cap wafer of FIG. 17;

FIG. 19 shows another result of processing the cap wafer of FIG. 14;

FIG. 20 shows another result of processing the cap wafer of FIG. 14;

FIG. 21 shows another result of processing the cap wafer of FIG. 14;

FIG. 22 shows another result of processing the cap wafer of FIG. 14;

FIG. 23 illustrates a method of further processing the semiconductor die wafer of FIG. 2;

FIG. 24 shows an intermediate result of the process of FIG. 23;

FIG. 25 shows a consecutive result of the process of FIG. 23;

FIG. 26 shows a consecutive result of the process of FIG. 23;

FIG. 27 shows a consecutive result of the process of FIG. 23;

FIG. 28 shows a consecutive result of the process of FIG. 23;

FIG. 29 shows a consecutive result of the process of FIG. 23;

FIG. 30 shows the cap wafer of FIG. 18 prior to wafer bonding;

FIG. 31 shows a cross-section of an intermediate result of the process of FIG. 5B;

FIG. 32 shows a cross-section of an intermediate result of the process of FIG. 5A;

FIG. 33 shows a consecutive result of the process of FIG. 5A;

FIG. 34 shows a consecutive result of the process of FIG. 5A;

FIG. 35 shows a MEMS transducer on a substrate in top port configuration;

FIG. 36 shows a MEMS transducer on a substrate in bottom port configuration;

FIG. 37A shows a perspective bottom view of the MEMS transducer of FIG. 35;

FIG. 37B shows a perspective top view of the MEMS transducer of FIG. 35;

FIG. 37C shows a cross-section of the a MEMS transducer of FIG. 35;

FIG. 38A shows a perspective bottom view of the MEMS transducer of FIG. 36;

FIG. 38B shows a perspective top view of the MEMS transducer of FIG. 36;

FIG. 38C shows a cross-section of the a MEMS transducer of FIG. 36;

FIG. 39 shows a top view of a die wafer and an enlarged part thereof; and

FIG. 40 shows a cross-section of a die wafer and cap wafer indicating various acoustic options.

### DETAILED DESCRIPTION

The following describes a process and some variants thereof for manufacture of a packaged MEMS transducer such as a MEMS microphone. Rather than completely enclosing the transducer element with some additional structural components such as printed circuit board (PCB) substrates connected to metal lids or laminate, i.e. 3-piece pcb, packages, chip-scale packaging techniques are adapted together with micro-machining techniques to provide the transducer package.

The transducer package according to some embodiments disclosed herein provide lead, i.e. solder, pads supporting a solder bump structure for electrical connection of the output signal and power supply (V+ and ground) on one face, i.e. one surface, of the package, which may be regarded as the bottom face or bottom surface of the package. The same transducer package may be mounted with its bottom face attached to a host substrate such as a PCB or suchlike in various ways, allowing for acoustic signals to enter the transducer package either through an aperture in the underlying PCB (“bottom-port mounting configuration) or via an aperture in the opposite (top) surface of the package (top port mounting configuration). A variant of the package allows signals to ingress via a side of the package different from the top or bottom surfaces. It will be appreciated that the “bottom surface” as described above will be “top” surface in the event that the package is inverted.

The disclosed package generally comprises a semiconductor die portion, or die substrate portion, being a semiconductor die incorporating a MEMS transducer element manufactured, at least in part, in previous processing steps. The die may also contain electronic circuitry, whether analogue and/or digital, such as, for example, amplifier buffer circuitry and other circuitry, such as a charge pump, that is useful to drive, control and/or process signals from the transducer. The package also generally comprises a cap portion overlying and attached to the die portion which may also comprise semiconductor material.

The footprint of the transducer package is the same as the footprint of a semiconductor die containing the actual transducer element, which die may also contain electronic circuitry as described above.

The size and weight of such a transducer package is thus small. The process described herein may advantageously allow thousands of transducers to be batch produced, i.e. processed simultaneously thus reducing the manufacturing time, effort and cost of each individual package.

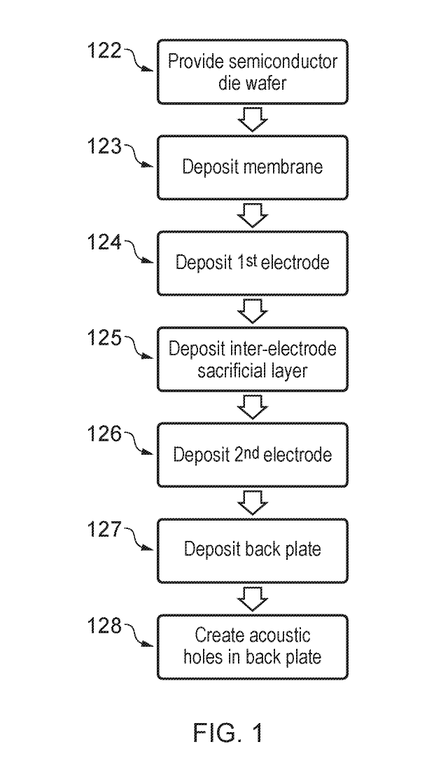

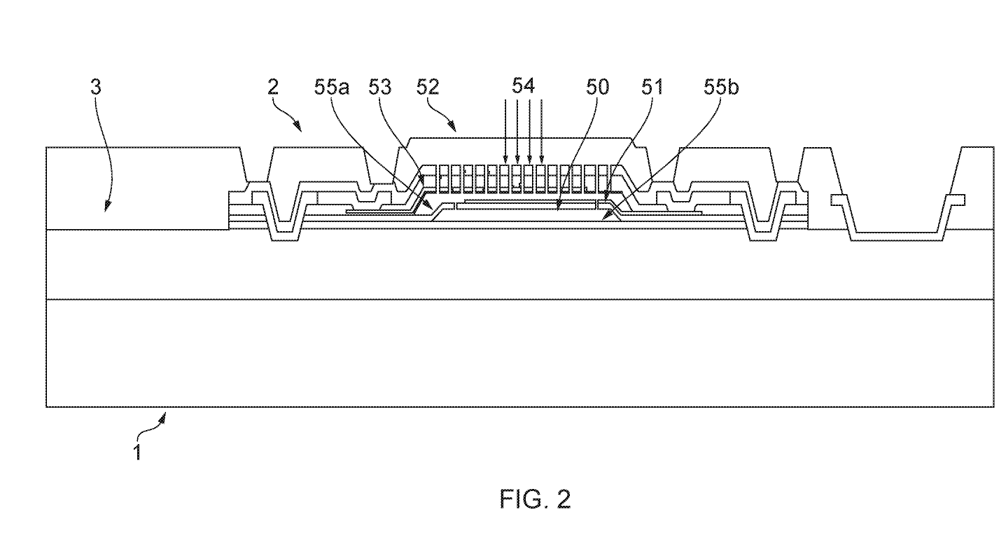

FIG. 1 shows the key steps of a process flow for one of many possible methods of preparing a semiconductor die wafer to serve as the die portion of the packaged transducer according to the following disclosure; which will be further referred to as a front side pre-fabricated semiconductor die wafer. The process is applied to the die wafer which will contain multiple transducers distributed across the surface of the die wafer. In the interests of clarity and brevity, the steps of FIG. 1 after the first step 122 of “providing a semiconductor die wafer” relate to an individual die of the semiconductor die wafer but it should be understood that each die of the semiconductor die wafer will be subject to each of the process steps of FIG. 1. The die wafer will also contain multiple intermediate products during intermediate steps of the fabrication process. Applying the process to the die substrate wafer provides a front side pre-fabricated semiconductor die wafer 1 which may be further processed to provide part of the transducer package disclosed herein. FIG. 2 shows an example of an intermediate product subjected to further processing.

Referring to FIGS. 1 and 2, the method of providing the front side pre-fabricated semiconductor die wafer 1 starts with the step of providing 122 a semiconductor die wafer 1, then for each individual die the steps of, depositing 123 a membrane 50 on a front side 3 of the die wafer 1 and depositing 124 a first electrode 51 onto the membrane. An inter-electrode sacrificial layer 55 (later removed so as to mechanically release the membrane) is deposited 125 on the membrane and first electrode. Thereafter, depositing 126 a second electrode 53 onto the sacrificial layer 55 and depositing 127 a back plate 52 on the second electrode and sacrificial layer 55. Acoustic holes 54 are then formed 128 in the back plate 52. The membrane 50, electrodes 51, 53 and back plate 52 form a transducer element 56. This processing is all performed on the front side of the die wafer. It will be appreciated by those skilled in the art that the degree of pre-fabrication of the die wafer may vary from that which is disclosed herein and the prefabrication may just be the providing of a blank wafer that has not been subjected yet to all of the processing steps described above.

There are many variants of such a process. In some cases, the membrane or back-plate may comprise conductive material so a metal electrode may not be required. In some cases, for example, piezo-type, such as piezo-resistive, transducers, there may be no need for a back-plate. In some cases it is desirable that the membrane be mounted slightly above the surface of the actual wafer, and a second sacrificial layer may be deposited between the original wafer surface and the membrane layer.

The sacrificial layer 55 that was deposited 124 during the providing of the front side pre-fabricated semiconductor die wafer between the membrane 50 and the front side 3, or an oxide layer on the front side 3, of the semiconductor wafer 1 and between the membrane 50 and the back plate 52, and any second sacrificial layer, will advantageously serve to protect the thin membrane and to keep dust and chemicals etc. out of the narrow gaps between the membrane and back-plate and between the membrane and underlying silicon in the case of a silicon wafer. These sacrificial layers may be made from a polyimide material for example.

The semiconductor from which the die wafer is composed may be silicon. The membrane may be silicon nitride. The back-plate may also be silicon nitride.

The electrodes may be aluminium or an alloy thereof. The deposition and patterning may thus use standard proven silicon manufacturing technology, methods and equipment. The process steps involved in these transducer element manufacturing steps may be performed using relatively low temperatures, allowing active circuitry to be pre-formed on the same wafer and die in previous processing steps, i.e. the pre-fabricated die wafer may already comprise the active, i.e. electronic, circuitry, and thus not suffer from degradation due to thermal or other effects during the transducer element manufacturing steps. In some cases, the transducer may be manufactured first, or at least most steps performed first, with the active circuitry processed afterwards.

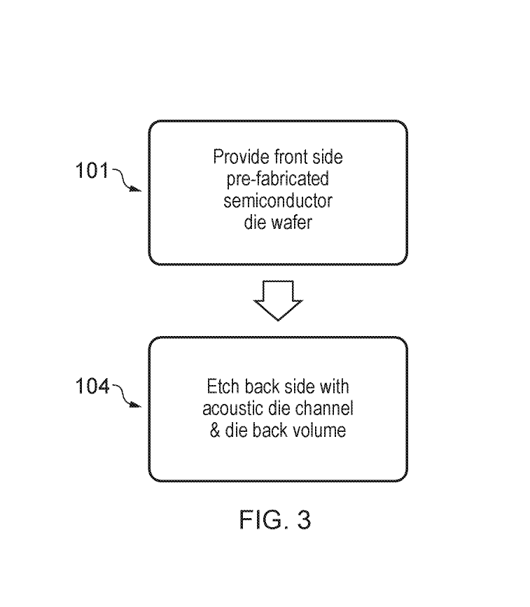

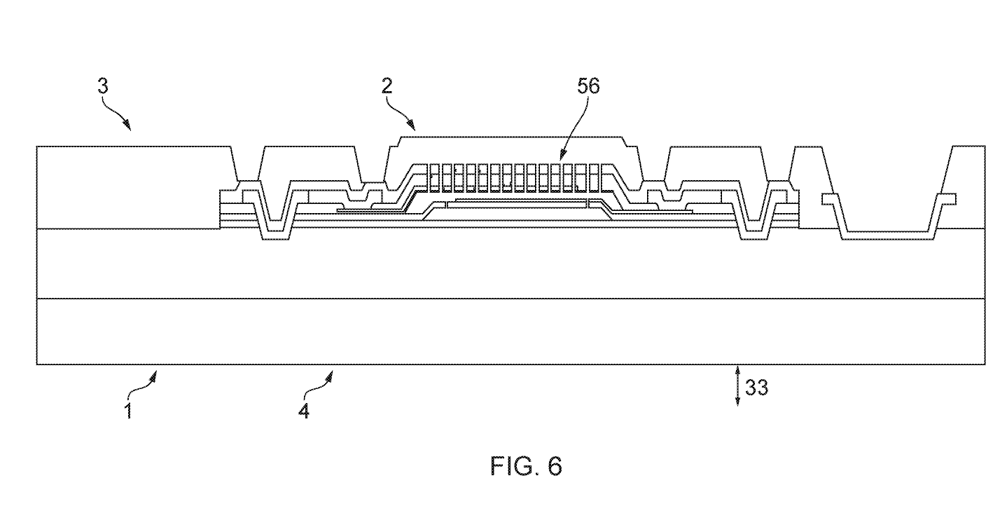

FIGS. 3 to 5 show key steps in an example of a process flow as herein disclosed for a method of fabricating a micro-electrical-mechanical system (MEMS) transducer package. Not all steps may be necessary in any particular variant of the general method. Intermediate results are shown in more detail in FIGS. 6 to 17.

Referring to FIG. 3, the method starts out with providing 101 a front side pre-fabricated die wafer 1, such as e.g. obtained by the process as described under reference to FIG. 1. In a further step, the front side pre-fabricated die wafer 1 is subjected to back etching 104 at the back side 4 (i.e. the opposite side of the wafer to the front side previously processed on), wherein the back etching 104 of the die wafer 1 includes etching an acoustic die channel 5 and a die back volume 6 as described further below.

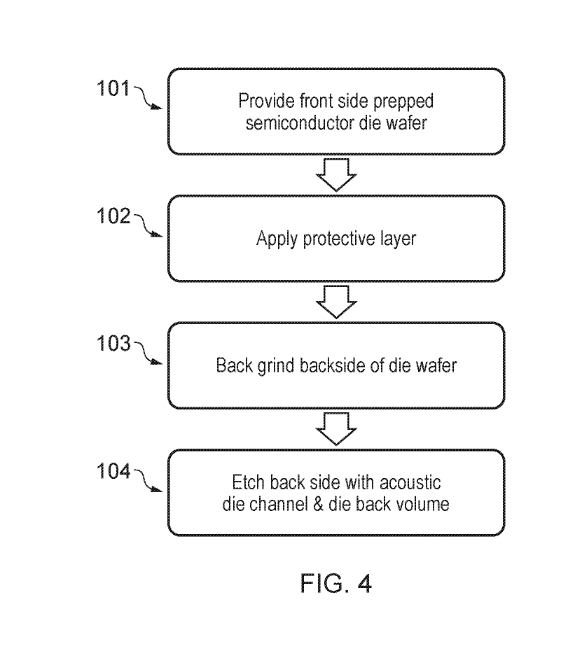

In more details, in this embodiment, as shown in FIG. 4, in addition, in this embodiment applying 102 a protective layer 2 to the front side 3 of the semiconductor die wafer 1 may be performed prior to back etching 104 and back grinding 103 the semiconductor die wafer 1. The protective layer 2 protects the transducer element 56 in particular from damage during further processing.

Referring back to FIG. 2, this figure shows the protective layer 2 as deposited over the front side of the die wafer. This layer 2 protects the holes in the back-plate, for example from gathering debris during subsequent wafer dicing operations. It also serves to more generally to protect the surface of the wafer from mechanical damage, except where it is deliberately exposed to allow other structures to be added. This layer may also be a polyimide material.

After step 102 of FIG. 4 a step of back grinding 103 the die wafer 1 may be performed prior to back etching 104 the wafer 1. By back grinding 103 the semiconductor wafer 1 it is brought to a predetermined thickness which is less than the original semiconductor wafer. This allows for a thinner wafer and eventual package, and also advantageously reduces the time required to back etch structures through the thickness of the wafer.

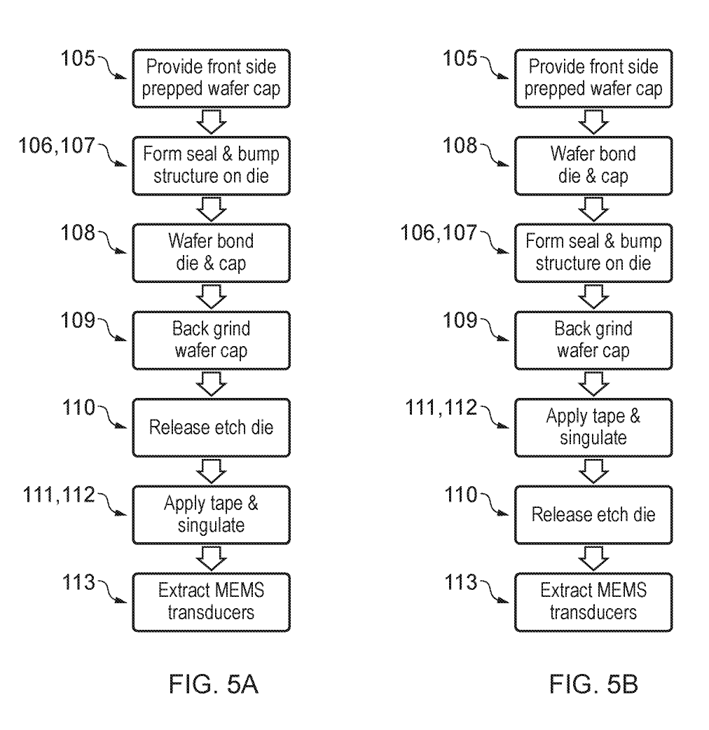

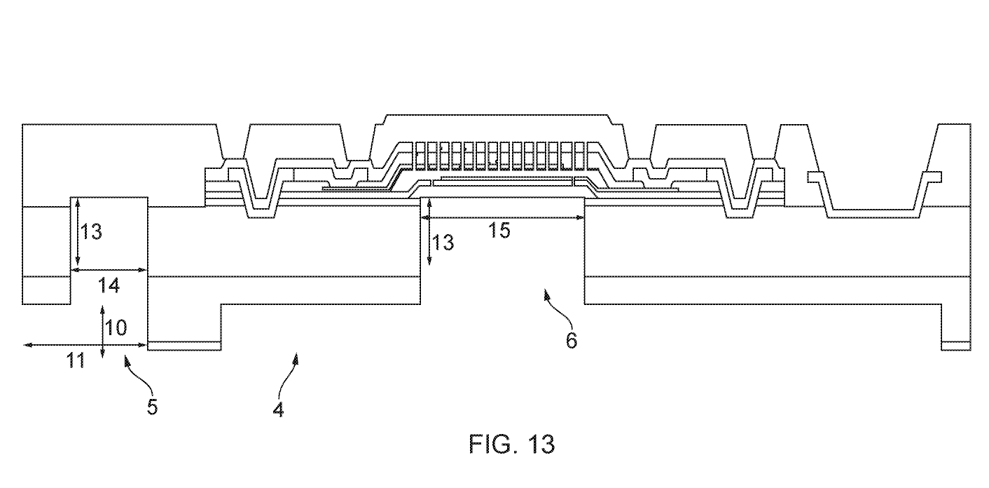

In following processing steps a capped wafer 31 will be fabricated by assembly together of the die wafer 1 and a semiconductor cap wafer 16. Referring to FIGS. 5A and 5B, the method thereto includes providing 105 a front side pre-fabricated cap wafer 16 and wafer bonding 108 the die wafer 1 and the front side pre-fabricated cap wafer 16 thereby constituting the capped transducer wafer 31. The step of providing the front side pre-fabricated cap wafer 16 will be described in more detail below with reference to FIGS. 13 to 17. The back side of the die wafer 1 is bonded 108 to a front side of the cap wafer 16. The front side 3 of the die wafer 1 then becomes one outer surface of the capped transducer wafer 31, and will eventually provide the “bottom” face of individual transducer packages. The back side 32 of the cap wafer becomes a second outer (“top”) side of the transducer wafer 31, which will eventually provide the opposite “top” face of individual transducer packages.

Further steps applied to the front side 3 of the die wafer 1 include forming a seal structure 106 and forming a bump structure 107. These steps may occur before the wafer bonding 108 as illustrated in FIG. 5A or after the wafer bonding as illustrated in FIG. 5B. The steps may occur before or after the back side etch 104 of the semiconductor die wafer.

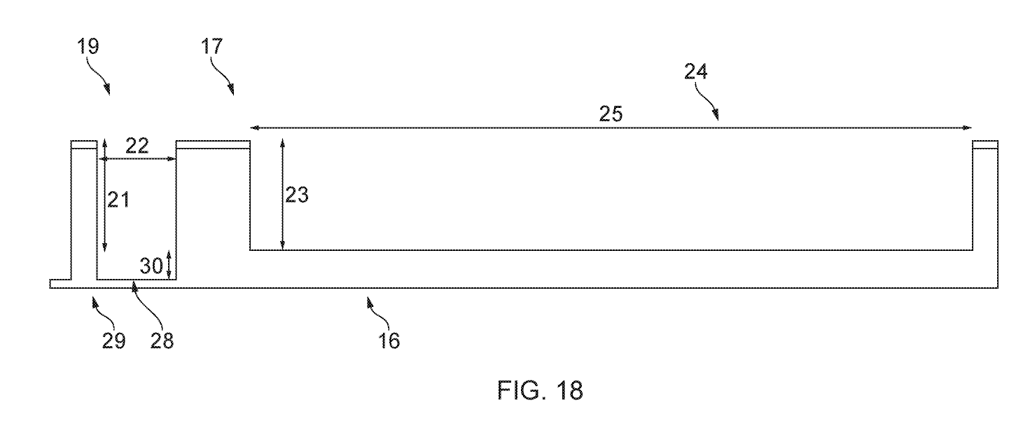

The seal structure will provide at least part of an acoustic seal structure when a finalised MEMS transducer package is placed on a host substrate. The host substrate may be part of a transducer package module, which itself is further mounted on another host substrate. Alternatively the host substrate may be the substrate of a device in which the MEMS transducer package is to be incorporated, such as e.g. a phone or tablet. The bump structure provides the connection bumps for connecting the finalised MEMS transducer package to the device in which it is to be incorporated. Further details of forming the seal structure 106 and bump structure 107 will be discussed below under reference to FIGS. 18 to 24.

After the step of wafer bonding 108, the back side 32 of the cap wafer 16 is subjected to back grinding 109. The back grinding 109 removes a grind layer 28 that can be sacrificed from the back side of cap wafer 16, thereby reducing the cap wafer 16 to a desired thickness. The back grinding 109 may also be necessary to expose acoustic channels that were previously only etched part way through the original thickness.

Final steps prior to extracting 113 individual MEMS transducer packages from the capped transducer wafer 31 include release etching 110 the die wafer 1 to remove the inter-electrode sacrificial layer 55a, etching the protective layer 2 and additional sacrificial layer 55b if present, applying die attach film (DAF) or some other suitable film or tape 111 and singulating 112 the capped transducer wafer 31 to produce individual chip-scale, i.e. transducer-die-scale, transducer packages. The step of release etching 110 may be performed prior to applying film/tape 111 and singulating 112 as illustrated in FIG. 5A, or it may be performed after applying film/tape 111 and singulating 112 and prior to extracting transducers packages 113 as illustrated in FIG. 5B.

FIGS. 6 to 12 show illustrative cross-sections of the die wafer 1 as it is processed through steps 103 to 104 of FIG. 4. This process sequence starts from the front side pre-fabricated die wafer 1 of FIG. 2.

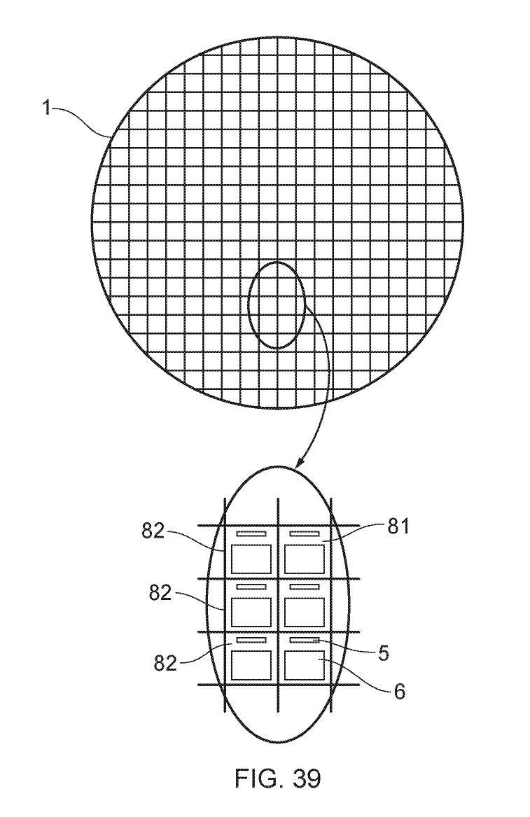

The accompanying figures as referred to in the discussions below, show cross-sections of die transverse to a plane defined by the wafer. FIG. 39 shows a top view of the wafer and the plane defined thereby. In the discussions below where a cross-section of a channel or that of a volume is indicated, one should bear in mind that the illustrated cross-sections are only indicated by a certain width.

Turning to FIG. 6, the wafer 1 is subjected to back grinding 103 to reduce the wafer thickness by an amount 33, in preparation for back etching 104.

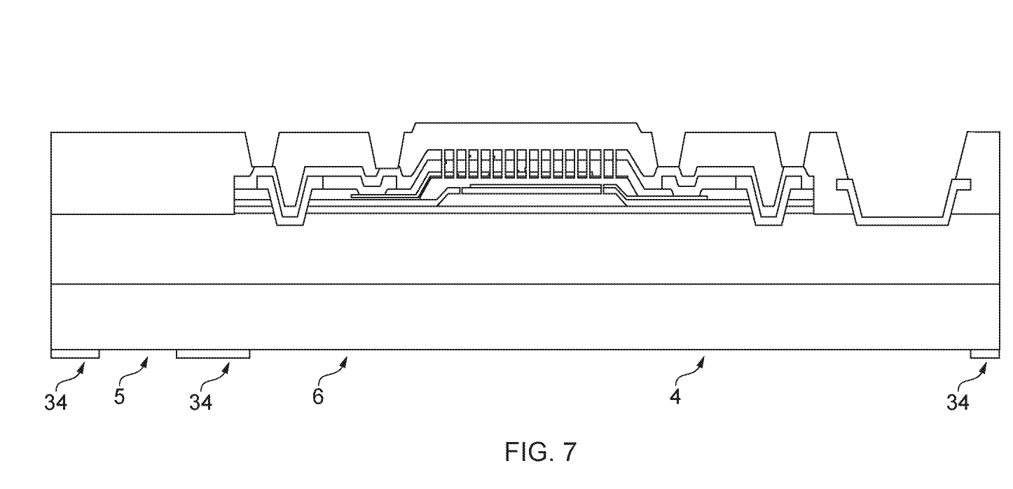

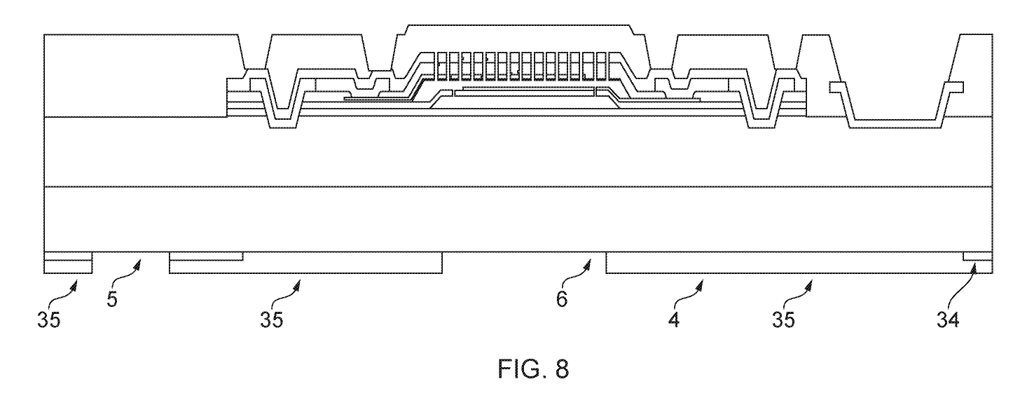

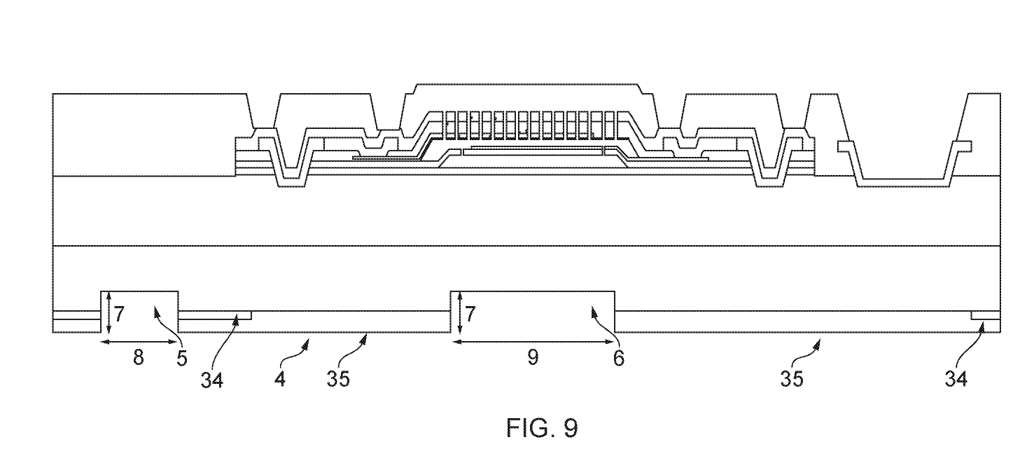

The back etching 104 may comprise etching of semiconductor material and/or dielectric material to obtain the acoustic die channel 5 and the die back volume 6, as shown in FIGS. 7 to 12. A hard mask 34 of etch-resist, or other suitable masking material such as nitride for example, is deposited on the back side (4) of the die wafer (1) (FIG. 7) prior to a first etch step, which prevents etching of material during a subsequent etch step. On top of the hard mask 34 and on certain other parts of the wafer 1, a resist mask 35 is deposited (FIG. 8). Next, the first wafer etch step is performed: etching the semiconductor material with a first depth 7 the acoustic die channel 5 with a first acoustic die channel cross-section 8 and the die back volume 6 with a first die back volume cross-section 9 (FIG. 9). The acoustic die channel cross-section 8 and the back volume cross-section 9 are determined by the resist mask 35. The depth 7 is determined by semiconductor processing materials, parameters and/or conditions such as temperature and the duration of the etching process.

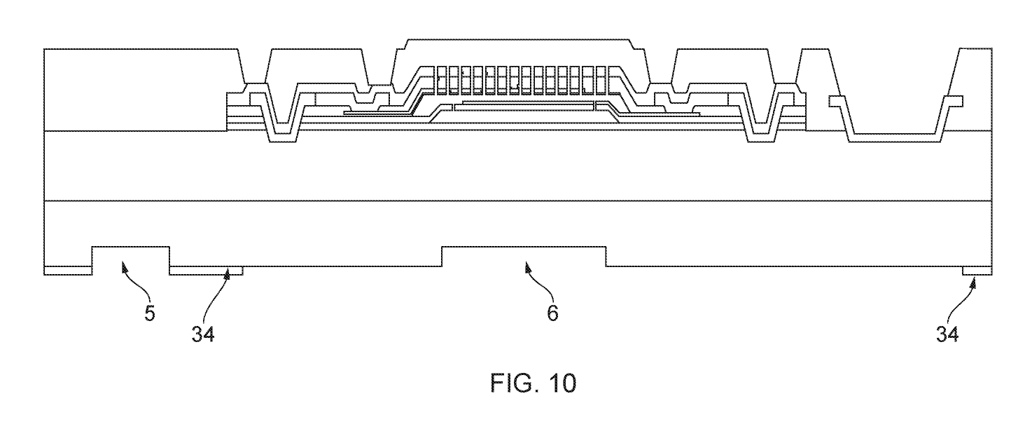

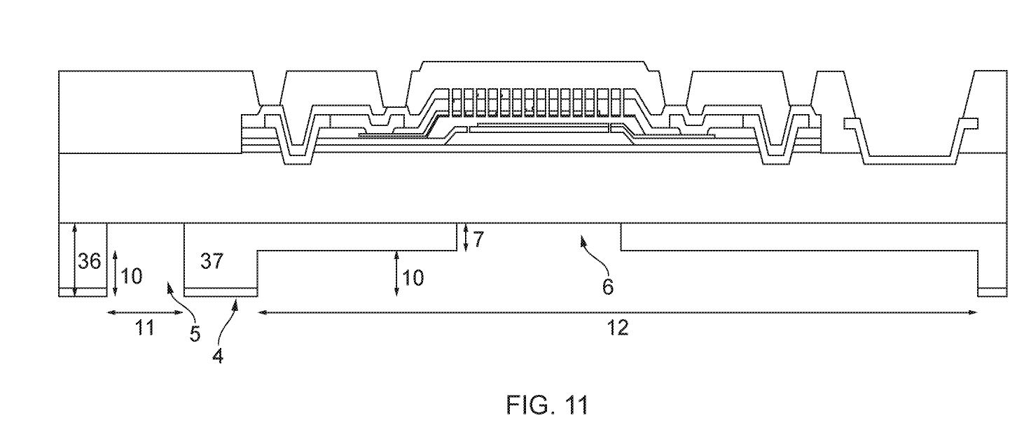

Prior to performing the second semiconductor etch step, the resist mask 35 is stripped, leaving the semiconductor material, e.g. silicon, and the hard mask 34 still present exposed, as shown in FIG. 10. Next, the second semiconductor etch step is performed (FIG. 11): etching with a second depth 10 the acoustic die channel 5 with a second acoustic die channel cross-section 11 and the die back volume 6 with a second die back volume cross-section 12 determined by the hard mask 34. Regions of the wafer which were previously protected by being covered by the resist mask 35 will be etched to a depth 10 determined by processing parameters of the etching process. Regions of the wafer which were previously unprotected and have already been etched with a depth 7 will be further etched to a maximum depth of the sum of dimensions 7 and 10.

Preferably dimensions 7 and 10 are controlled such that the sum is equal to the original (post-back-grind) thickness 36 of the die portion 37 of the wafer (1). However in practice the etch depth will be subject to some manufacturing tolerance, so in fact the total depth of etch in these regions is limited by terminating at a layer of some dielectric material, e.g. silicon oxide or silicon nitride dielectric, or etch-stop material, situated immediately on top of the die portion 37. The etchant is chosen with respect to such dielectric/etch-stop material so as to not etch it (or the hard mask material) while still being able to etch the semiconductor material. Thus the step 7 illustrated with respect to the back volume in FIG. 11 may be slightly less than the original etched depth 7 of FIG. 9.

Once the semiconductor material is etched, the dielectric material needs to be etched, and also any other layers for example other inter-metal dielectric layers which appear there in the process sequence for making the transducer element or any co-integrated active circuitry. This involves dielectric etching with a third depth 13 the acoustic die channel 5 with a third acoustic die channel cross-section 14 and the die back volume 6 with a third die back volume cross-section 15. The third depth 13 may be defined by an etch stop layer provided at a required height. In the case of the region beneath the MEMS transducer element it may be the membrane or as shown the second sacrificial layer 55b. In the case of the acoustic channel 5 it may again by a local layer of the same sacrificial layer, or may be some other local layer, such as protective layer 2, of material that will be removed later in the process to expose the top of the acoustic channel.

In this embodiment, the first acoustic die channel cross-section 8, the second acoustic die channel cross-section 11, and the third acoustic die channel cross-section 14 are all the same in cross-section. The first die back volume cross-section 9 and the third die back volume cross-section 15 correspond to a cross-section of the transducer element 56. These volume cross-sections may be slightly smaller than the full cross-section of the transducer element to allow for clearance from peripheral support structures and suchlike of the transducer element, as well as possibly manufacturing tolerances in sizes and relative alignment.

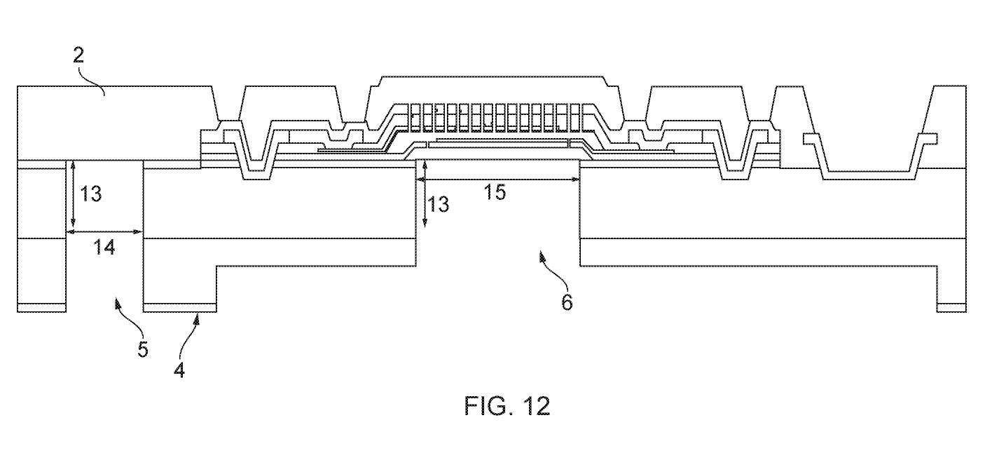

In the resulting structure as shown in FIG. 12 the bottom of acoustic die channel 5 opens only to the back side 4 of the die. In another embodiment, as shown in FIG. 13, the acoustic channel 5 may comprise a first portion of cross-section 8 etched to the full depth of the die and a second portion etched to only the same depth 10 as the shallower part of the back volume 6. The second etched portion may extend to the edge of each respective the die, thus being open (after singulation) to a side of the die, providing a side port of height 10. The second depth 10 may or may not be designed to equal the first acoustic die channel cross-section 8 depending on design objectives and constraints. The first acoustic die channel cross-section 8 and the third acoustic die channel cross-section 14 are the same. And the second acoustic die channel cross-section 11 is such that the second acoustic die channel cross-section extends to a side of the die wafer 1 to form the side port. The first die back volume cross-section 9 and the third die back volume cross-section 15 correspond to a cross-section of the transducer element 56. In this embodiment, the acoustic die channel 5 shows an angular path, while the respective path cross-sections defined by dimensions 8 and 10 may be designed to be similar, thereby providing unhampered passage of sound.

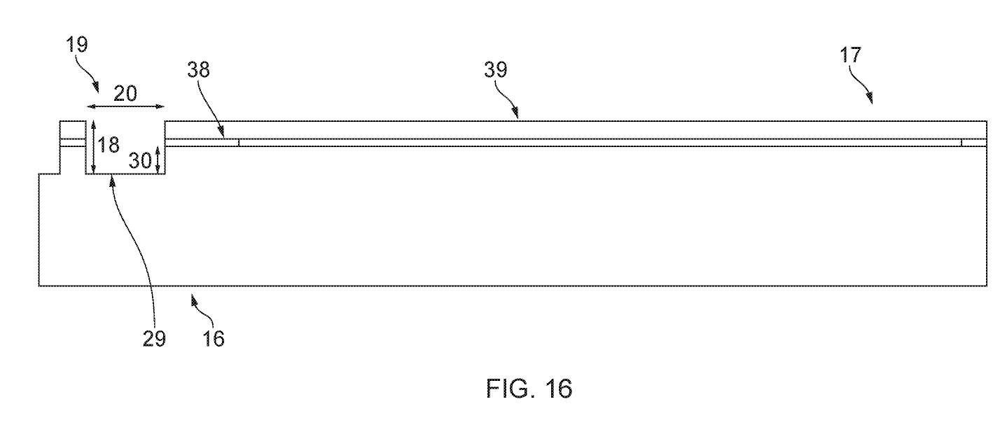

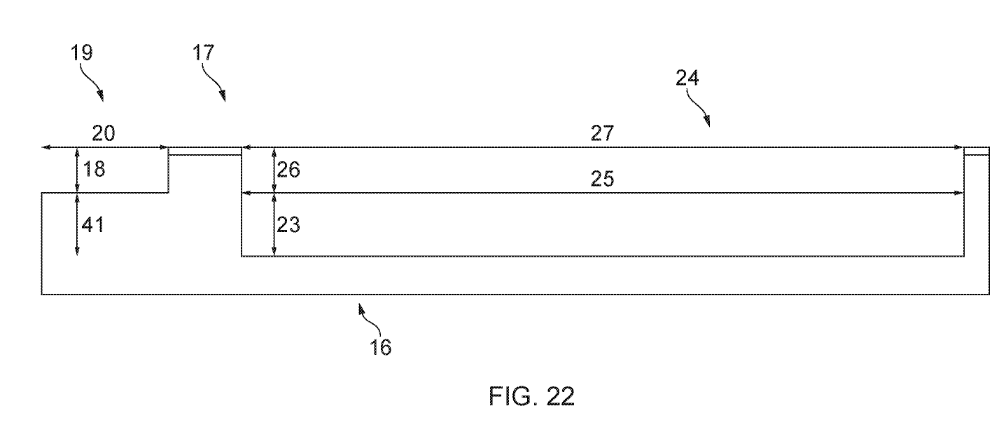

Now the step of providing the front side pre-fabricated cap wafer 16 is discussed in more detail. The preparing of the front side 17 of the provided cap wafer 16 may include several steps of etching to obtain an acoustic cap channel 19 with a predetermined depth and cross-section and a cap back volume 24 with a predetermined depth and cross-section. Depending on the desired configuration, the following different steps may be combined:
A) etching with a first depth 18 the acoustic cap channel 19 with a first cross-section 20 (see FIG. 16); and/or
B) etching with a second depth 21 the acoustic cap channel 19 with a second cross-section 22 (see FIG. 18); and/or
C) etching with a third depth 23 the cap back volume 24 with a third cross-section 25 (see FIG. 18); and/or
D) etching with a fourth depth 26 the cap back volume 24 with a fourth cross-section 27 (see FIG. 22).

In the steps described above, the cross-sections are defined by the lay-out of a first mask 39 and a second mask 38 which determines the regions that are subjected to the etchant during consecutive etching steps.

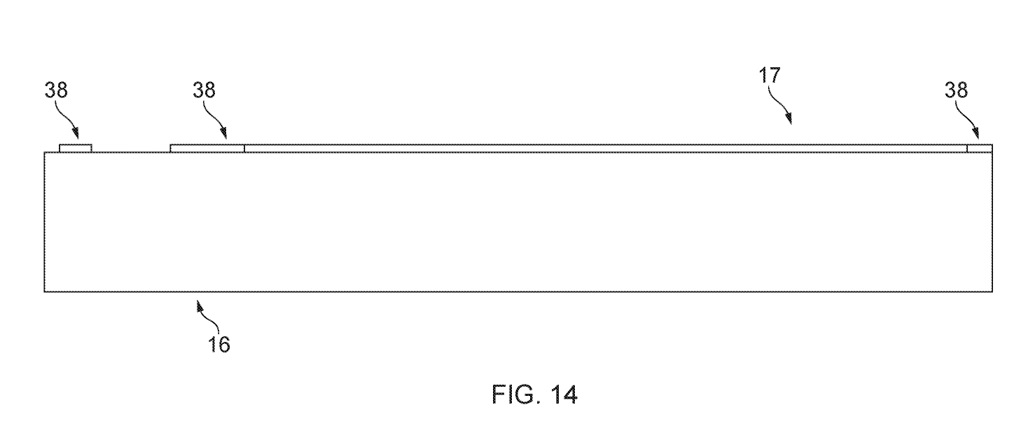

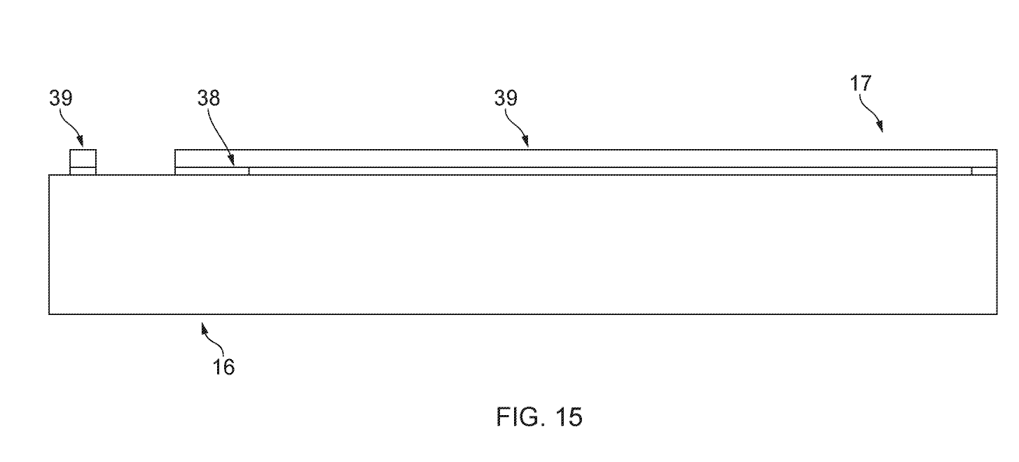

Referring to FIGS. 14 to 18, the step of providing a front side pre-fabricated cap wafer 16 for a top port configuration with the back volume extending into the cap wafer 16 is discussed. The un-pre-fabricated cap wafer 16 is provided and at a front side 17 a second mask, hard mask 38, is deposited for a second etch step (FIG. 14). On top of the hard mask 38, and over certain other areas of the cap wafer, a first mask, resist mask 39, is deposited, see FIG. 15. To obtain the top port configuration, step A as mentioned above is performed, followed by performing steps B and C simultaneously.

In step A the region of the cap wafer of first cross-section 20 defined by being uncovered by the resist mask 39 (and uncovered by any hard mask material) is etched with a first depth 18 (FIG. 16) defined by etch processing parameters

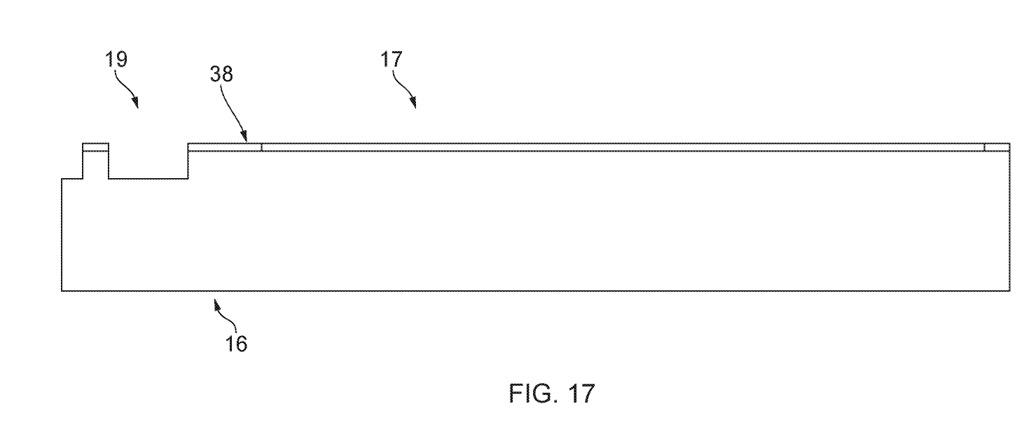

Prior to the simultaneous performing of steps B and C, the resist layer 39 is removed exposing the hard mask 38, see FIG. 17. FIG. 18 shows the result of the etching of steps B and C.

In the region of the acoustic channel, a second cross-section 22 of the cap wafer is etched by an additional second depth 21 dependent on etch process parameters. The total depth is preferably chosen so as to leave a relatively thin layer of sacrificial material, i.e. a “grind layer” 28. If the full depth of the cap layer were to be etched, any remaining etch time might cause the etchant to start attacking the semiconductor material, e.g. silicon, near the newly exposed edges. In some embodiments the back side of the cap wafer might have some etch stop layer, e.g. a dielectric such as silicon oxide or nitride or some other etch-stop material to ensure the etch will not etch the full thickness and to give less uncertainty in the thickness of material remaining to be later removed.

Assuming the resist mask 35 does not extend past the cross-section of the hard mask 38, both the first cross-section and the second cross-section are defined by the same gap in the hard mask, so will be the same, providing acoustic channel segments of the same cross-section,

In the region of the cap back volume, a third cross-section 25, defined by the hard mask 38, of the cap wafer is etched to a depth 23 defined by etch process parameters. As steps B and C are performed simultaneously, the respective areas not covered by the hard mask 38 are exposed to etching with the same etching parameters including the same duration, resulting in depth 21 and 23 being the same.

Depth 23 and cross-section 25 may be chosen such that the back volume etched out of the cap is as large as possible while retaining mechanical integrity and reliability of the cap in the remaining semiconductor material remaining under and to the side of the volume.

The total acoustic channel depth is the sum of the first and second depths 18, 21 and may be designed to be sufficiently less than the initial thickness of the cap wafer 16 such that even with manufacturing variations the maximum cumulative etch will never break through the opposite surface. If there is an etch stop layer on the back side of cap wafer 16, the total depth may be designed such that even with manufacturing variation the minimum cumulative etch will be adequate to reach the etch stop layer. In either case, at the bottom 29, the grind layer 28 remains which will be removed during the step of back grinding 109 the cap wafer 16

First depth 18 of the acoustic cap channel 19 determines a difference in depth 30 of the acoustic cap channel 19 and the cap back volume 24. The first cross-section 20 of the acoustic cap channel 19 corresponds with the second cross-section 22 of the acoustic cap channel 19. In step B the second depth 21 of the acoustic cap channel 19 is such that just the grind layer 28 remains at a bottom 29 of the acoustic cap channel 19. And the second cross-section 22 of the acoustic cap channel 19 corresponds with the third cross-section 14 of the acoustic die channel 5. In step C the third depth 23 of the cap back volume 24 is the same as the second depth 21 of the acoustic cap channel 19. And the first cross-section 25 of the cap back volume 24 is at least equal or larger than the third cross-section 15 of the die back volume 6. The difference between the intermediate bottom 29 of the acoustic cap channel 19 and the front side 17 of the cap wafer 16 is designated by the reference numeral 30.

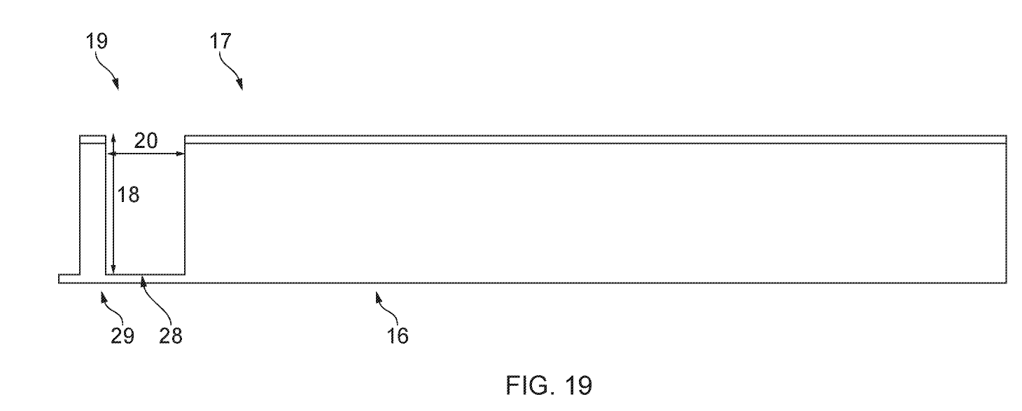

FIG. 19 shows a structure resulting after step B is performed where the hard mask layer 38 extends across all of the front surface 17 of the cap wafer 16 except in the region of the acoustic channel. The second depth 21 of the acoustic cap channel 19 is such that just the grind layer 28 remains at the bottom 29 of the acoustic cap channel 19. This provides a pre-fabricated cap wafer comprising an acoustic channel segment but no cap wafer back volume.

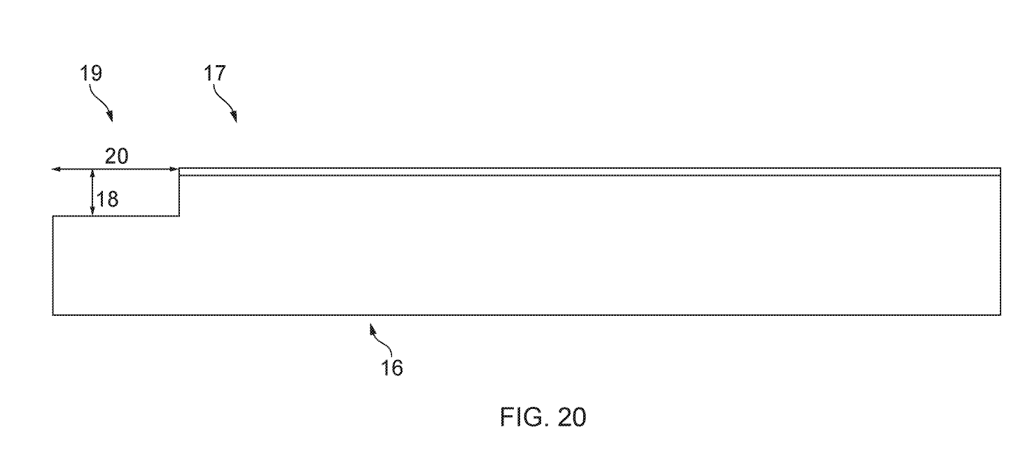

FIG. 20 shows yet another result wherein just step B is performed. Herein the second cross-section 22 of the acoustic cap channel 19 is such that the acoustic cap channel 19 extends to a side of the cap wafer 16 to form a side port in a similar way to that discussed with relation to the side port produced in the semiconductor die wafer of FIG. 13.

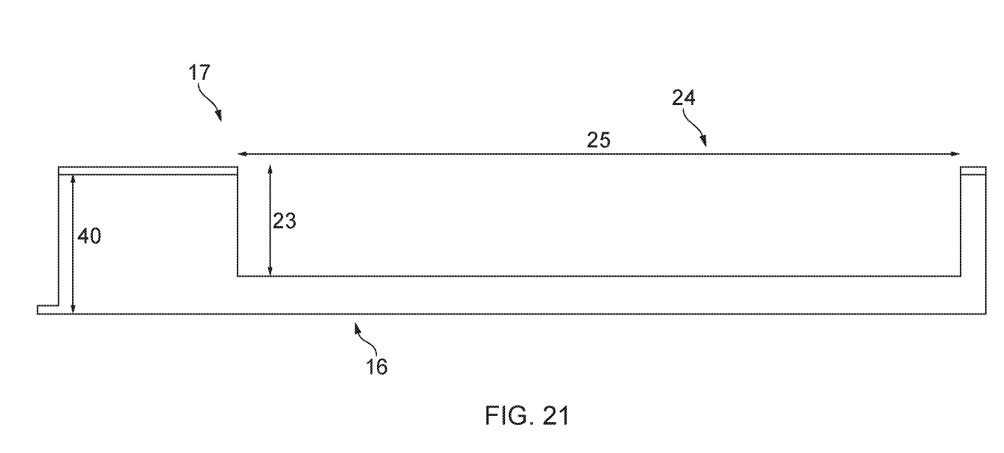

FIG. 21 shows another result wherein just step D is performed. Wherein the fourth depth 26 of the cap wafer back volume 24 may range from ⅕ to ⅘ for example of a thickness 40 of the cap wafer 16. And wherein the fourth cross-section 27 of the cap wafer back volume 24 may be at least equal or larger than the third cross-section 15 of the die back volume 6 of a companion semiconductor die portion.

FIG. 22 shows another result wherein step C is performed, followed by performing steps B and D simultaneously. In step C the acoustic channel region is protected by resist mask 35 in a similar way to above so only a third cross-section 25 of cap back volume uncovered by hard mask 38 and uncovered by the resist mask 35 is etched, to a third depth 23. The resist mask 35 is removed prior to steps B and D. In step D, a fourth cross-section 27, defined solely by the hard mask 38, of the cap wafer back volume 24 is etched further by a fourth depth. Simultaneously according to step B a second cross-section 22, defined solely by the hard mask 38, of the acoustic channel region is etched to a second depth 21. As the second depth 21 and fourth depth 26 are produced under the same etching conditions they are equal, so the difference in eventual total depth 41 of the cap wafer back volume 24 and the acoustic cap channel 19 is defined by the third depth 23. As illustrated, the second cross-section 22 of the acoustic cap channel 19 is such that the acoustic cap channel 19 extends to a side of the cap wafer 16.

In embodiments where only steps A and/or C are employed, or where only steps B and/or D are employed, there is no need for both the hard mask and the resist mask to be used, so only one of these layers need be deposited and patterned to protect the relevant parts of the cap wafer surface.

The final cross-section on the cap wafer surface at the acoustic channel may be designed to cooperate with anticipated choices of companion die wafer portions. For example in step A (or B) the first cross-section 20 (second cross-section 22) of the acoustic cap channel 19 may correspond with the third cross-section 14 of the acoustic die channel 5 of a particular design of die portion so that the cross-section of the acoustic channel remains constant. Similarly the acoustic channel depth 21 of the side-port-compatible variants may be chosen to be the same or similar to the third cross-section 14 of the acoustic die channel 5 of a particular design of semiconductor die portion to avoid a discontinuity in acoustic impedance along the channel. However in some cases these cap wafer channel dimensions may be deliberately chosen to be some ratio or different to deliberately provide a tailored step in acoustic impedance at the wafer-to-wafer interface.

The final cross-section on the cap wafer surface of the cap wafer back volume may be designed to cooperate with anticipated choices of companion die wafer portions. For example in step C (or D) the third cross-section 25 (fourth cross-section 27) of the acoustic cap channel 19 may correspond with the cross-section 12 of the back volume 6 of a particular design of die portion so that the cross-section of the back volume remains constant. However in some cases these cap wafer back volume channel cross-sections may be deliberately chosen to be different to improve the trade-off between mechanical strength and back volume size of the overall structure.

Where the acoustic channel is etched according to both steps A and B, the boundary of the first resist mask 39 at the acoustic channel may coincide or be less than that of the underlying second mask or hard mask 38, so that the first and second cross-sections are both defined by the hard mask and are thus equal, to provide an acoustic channel within the cap wafer that is of uniform cross-section. Alternatively, the first resist mask 39 at the acoustic channel may extend past the edge of the hard mask to define a first cross-section smaller than the second cross-section. This smaller cross-section will propagate down the acoustic channel during the step B to provide a final acoustic channel in the cap wafer which has a lower section of height equal to the first depth and first cross-section narrower than an upper section of depth equal to the second depth.

Where the cap wafer back volume is etched according to both steps C and D, the boundary of the first resist mask 39 at the vicinity of the cap wafer back volume may coincide or be less than that of the underlying second mask or hard mask 38, so that the third and fourth cross-sections are both defined by the hard mask and are thus equal, to provide a back volume within the cap wafer that is of uniform cross-section, i.e. has vertical sides or side walls with no discontinuity. Alternatively, the first resist mask 39 at the vicinity of the cap wafer back volume may extend past the edge of the hard mask to define a third cross-section smaller than the fourth cross-section. This smaller cross-section will propagate down the cap wafer back volume during the step D to provide a final cap wafer back volume which has a lower section of height equal to the third depth and third cross-section narrower than an upper section of depth equal to the fourth depth.

For example, the above etched surface widths of the acoustic cap channel (19) or the cap back volume (24) may be designed to equal the respective etched surface widths of the acoustic die channel (11) or the die back volume (12). More generally, the etching of the acoustic cap channel (19) or the cap back volume (24) may follow a layout that corresponds to a layout used to etch the acoustic die channel (5) or the die back volume (6) respectively of the die wafer (1).

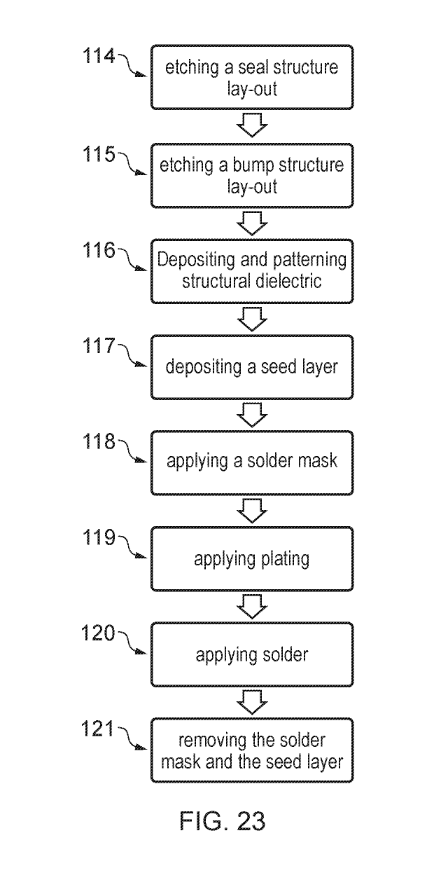

Referring to FIGS. 23 to 29, the steps of forming 106 the seal structure and of forming 107 the bump structure referred to in FIGS. 5A and 5B are discussed.

The description and diagrams assume that these process steps occur before the processing steps 103 and 104 shown in FIG. 4 and described with respect to FIGS. 6 to 12, but these process steps 106 and 107 occur on the front side of the wafer and steps 103, 104 occur on the back of the wafer, so the description may readily be applied to the case where 106 or 107 occur after steps 103 or 104.

FIG. 23 shows the steps that are performed: etching 114 a seal structure lay-out, etching 115 a bump structure lay-out, 116 depositing a patterning structural dielectric, depositing 117 a seed layer, applying 118 a solder mask, applying 119 plating, applying 120 solder and removing 121 the solder mask and the seed layer.

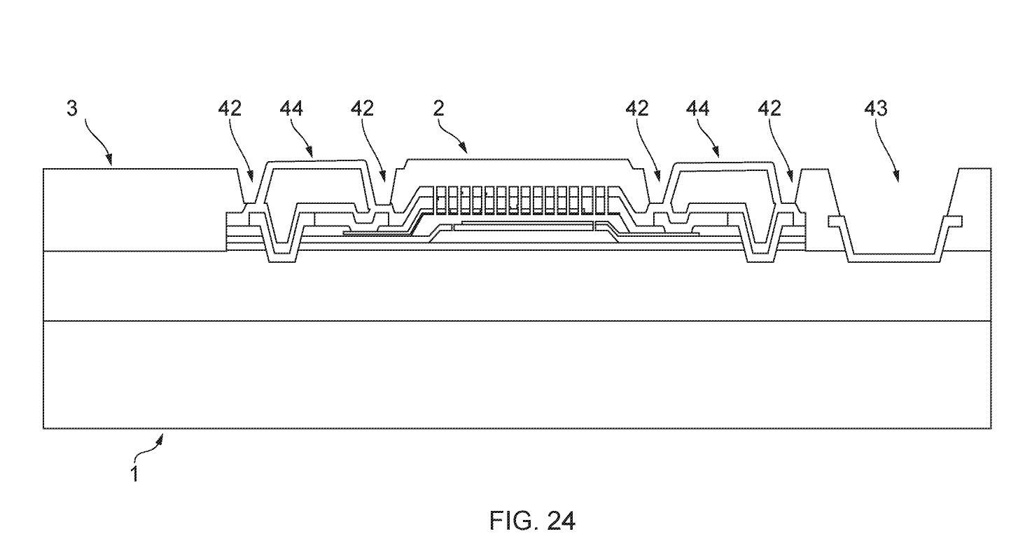

Referring back to FIG. 2, this illustrates the die wafer 1 with cut-outs in the protective layer 2 and other underlying areas. These cut-outs may comprise cut-outs 42 (labelled on FIG. 24), defined by previous processing comprising etching 115 a seal structure layout, marking tracks for a seal structure. These cut-outs may comprise a hole 43 (labelled on FIG. 24) defined by previous processing comprising etching 116 a bump structure layout, marking locations for later deposition of a bump metallisation structure.

FIG. 24 shows the semiconductor die wafer 1 after process step 116, depositing and patterning structural dielectric. Comparing with the cross-section illustrated in FIG. 2, it may be seen that additional dielectric, which may be silicon nitride (SiN), has been deposited and etched to cover the protective layer material 2 in certain areas of the die wafer surface. The protective layer material may be polyimide. These areas may be local to the seal structure, and the enclosed material 2 may provide structural support for the eventual seal structure and thus may be termed structural enclosed material, for example structural enclosed polyimide, and the locally overlying dielectric may be termed structural dielectric, for example structural silicon nitride. In this embodiment, the lay-out of the seal structure is such that the cut outs 42 in the protective layer 2 provide a stand-off bump 44 of structurally enclosed protective layer 2 material, i.e. in this embodiment polyimide. The bump 44 may advantageously provide a “stand-off”, i.e. a spacer, between the die and the host substrate.

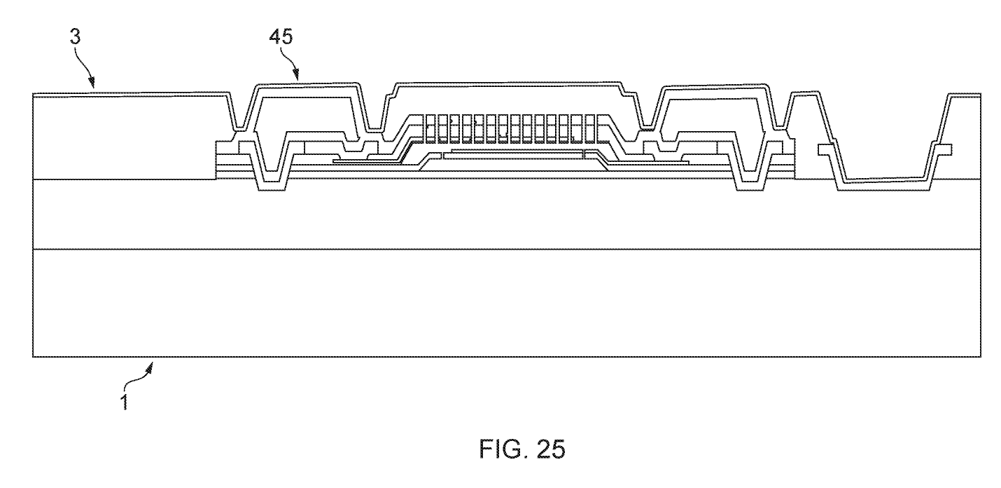

FIG. 25 shows the seed layer 45 deposited during step 117 at the front side 3 of the die wafer 1. The seed layer may be conductive. The seed layer may comprise barrier materials to improve the adhesion of copper onto the layers beneath, which may be of aluminium, silicon nitride, or polyimide in respective areas of the die. The barrier materials of the seed layer may also prevent diffusion of copper into the underlying material.

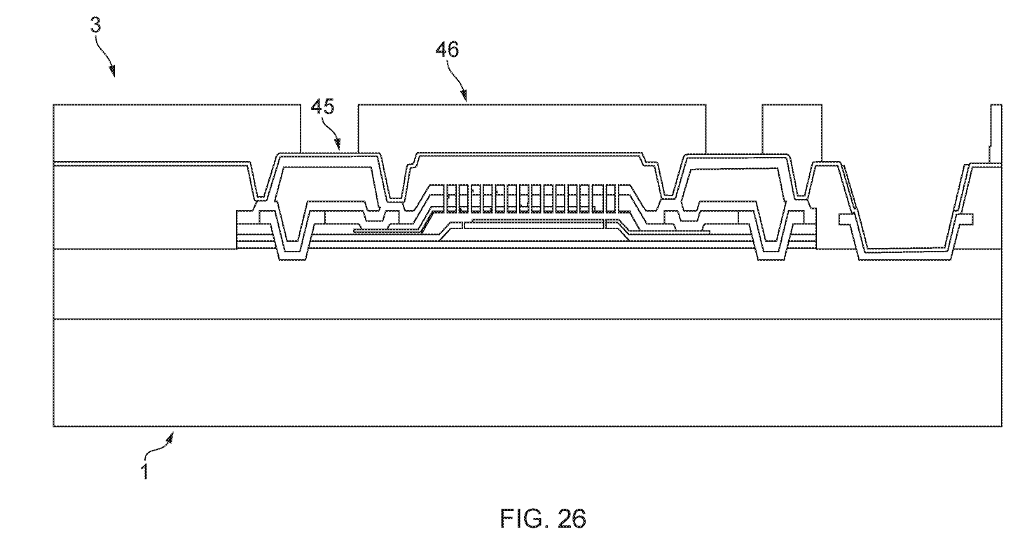

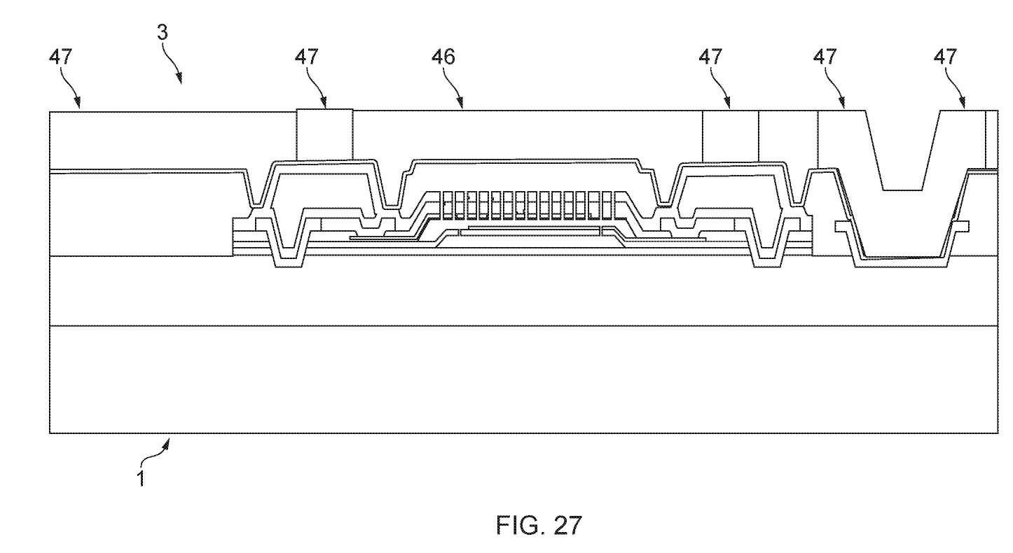

FIG. 26 shows the solder mask 46 i.e. plating resist mask applied on top of the seed layer 45. In this embodiment, the plating applied 119 includes copper (Cu) 47 which fills the cavities provided by the plating resist mask 46, as can be seen in FIG. 27.

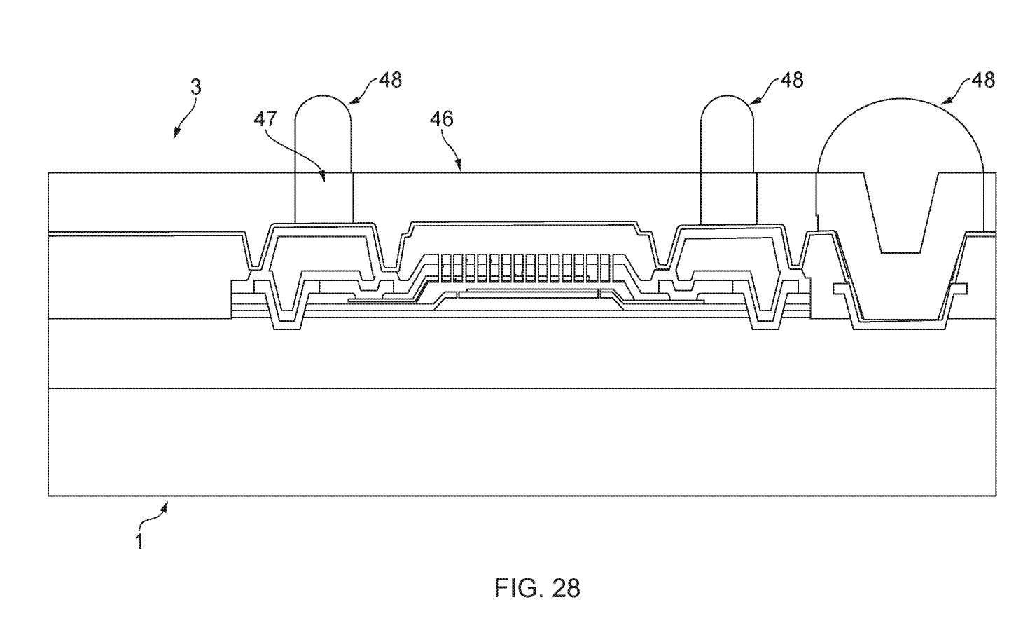

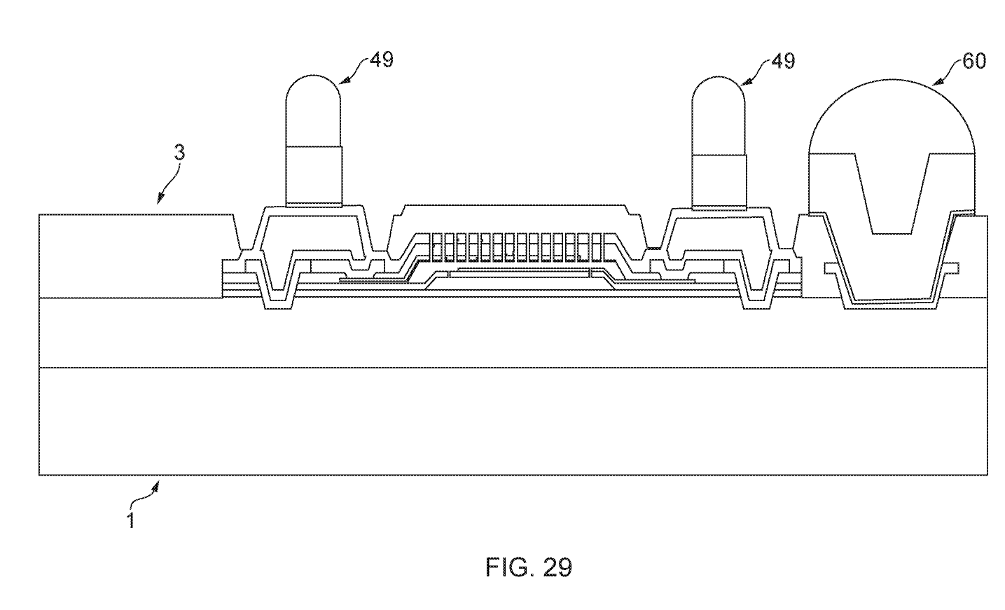

As seen in FIG. 28, on top of the copper 47 solder 48 is applied 120 by screen printing, plating or other suitable process, for instance by a solder mask (not illustrated) deposited on top of the plating resist mask 46. Once the solder 48 has solidified, the plating resist mask 46, and seed layer 45 may be removed 121, resulting in the die wafer as shown in FIG. 29 with seal structure 49 and bump structure 60.

This concludes steps 106 and 107. As discussed above, these steps may occur before or after wafer bonding step 108 of FIGS. 5A and 5B or even before die wafer back-grind and back-etch steps 103 or 104 of FIG. 4.

To provide the chip scale packaged transducer, the die wafer and cap wafer have to be attached together, and eventually singulated and extracted, i.e. separated, as individual wafer level transducer packages through the remaining steps illustrated in FIG. 5A or 5B.

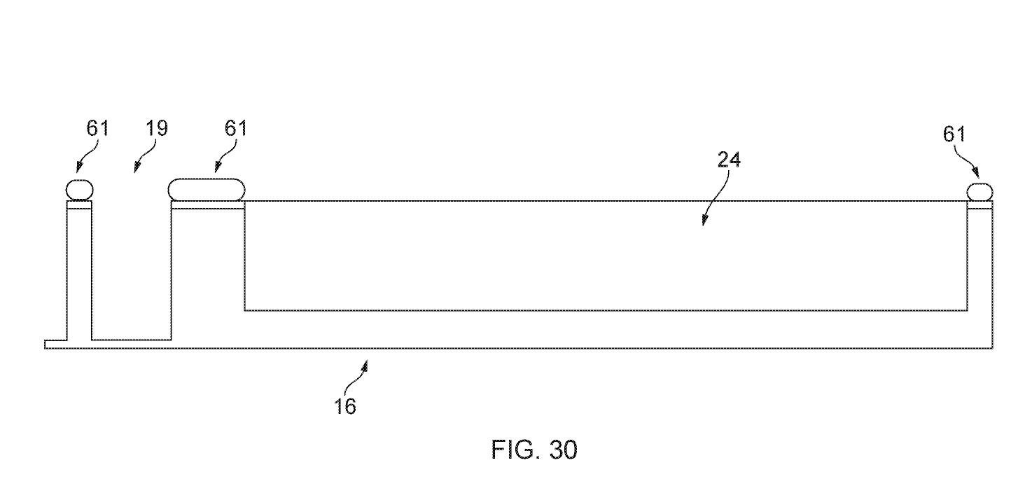

Turning to FIG. 30, the front side pre-fabricated cap wafer 16 is shown as obtained by the steps described in relation to FIG. 18. In this embodiment, a polymer adhesive 61 may be applied to the cap wafer 16. In another embodiment, the adhesive 61 may be applied to the die wafer 1 or to both the cap wafer 16 and the die wafer 1. In some embodiments the adhesive may be inorganic. In some embodiments other methods of mechanical wafer bonding may be employed for instance direct bonding, plasma activated bonding, anodic bonding, eutectic bonding, glass frit bonding, thermocompression bonding, reactive bonding, or transient liquid phase diffusion bonding.

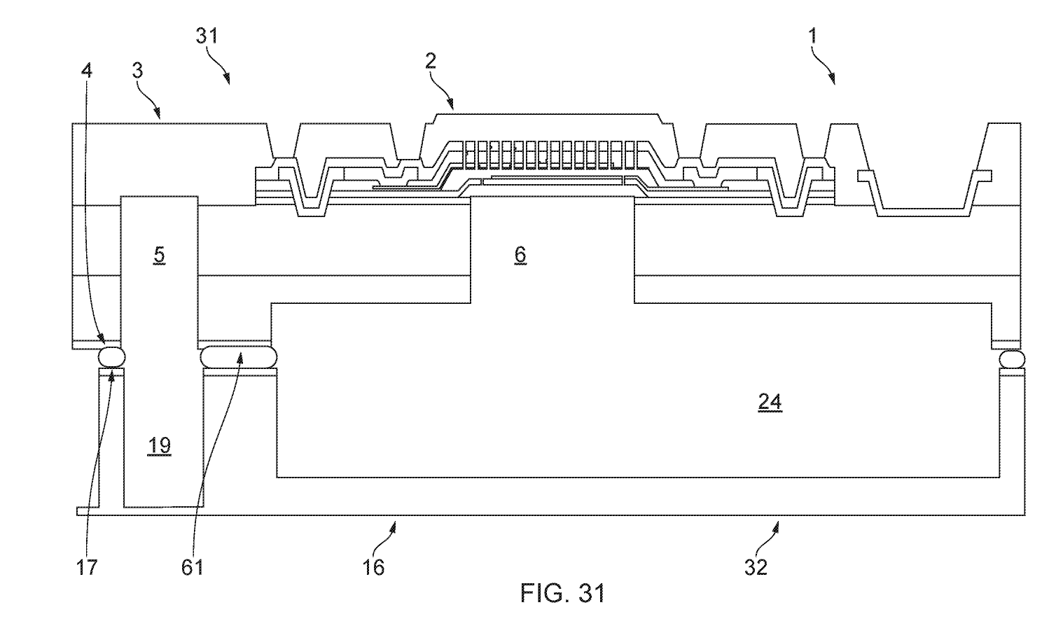

In FIG. 31, the result of wafer bonding 108 the die wafer 1 and the cap wafer 16 is shown. The back side 4 of the die wafer is bonded to the front side 17 of the cap wafer 16, while the front side 3 of the die wafer 1 and back side 32 of the cap wafer 16 are located on opposite outer sides of the capped wafer structure 31. In this embodiment, forming 106 of the seal structure and forming 107 of the solder bump structure has not been performed yet. As explained above, these steps may be performed after the step of wafer bonding 108.

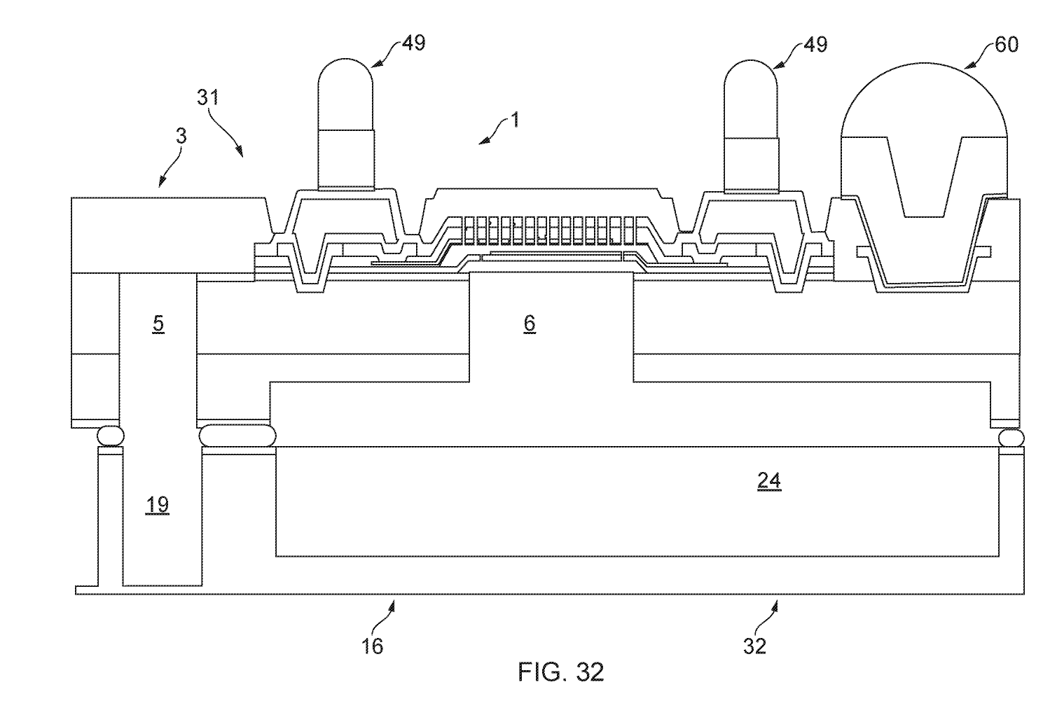

FIG. 32 shows the MEMS transducer wafer 31 with seal structure 49 and bump structure 60 present, i.e. after steps 106, 107 and 108 have been performed in whatever order.

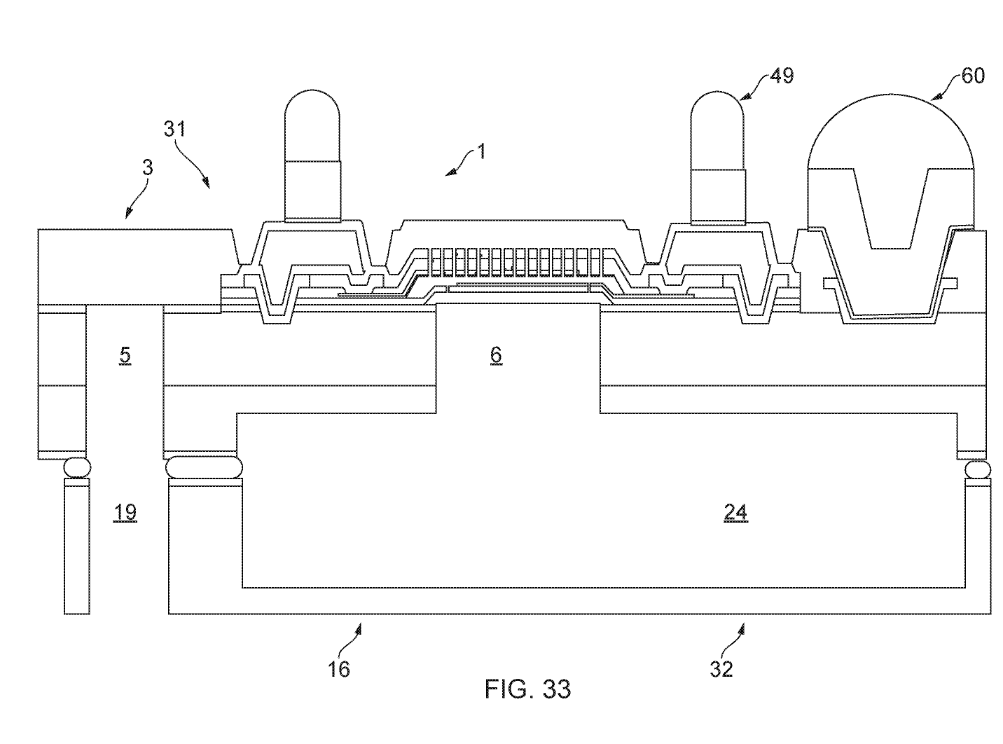

After the wafer bonding, the back grinding 109 of the back side 32 of cap wafer 16 may be performed. This back grinding 109 may either etch off some predefined thickness of the semiconductor material. If the acoustic cap channel 19 is terminated by an etch-stop layer of some other material (not illustrated), this may be mechanically or chemically removed. In either case, this opens up one end of the acoustic cap channel 19 to the outside environment, as seen in FIG. 33.

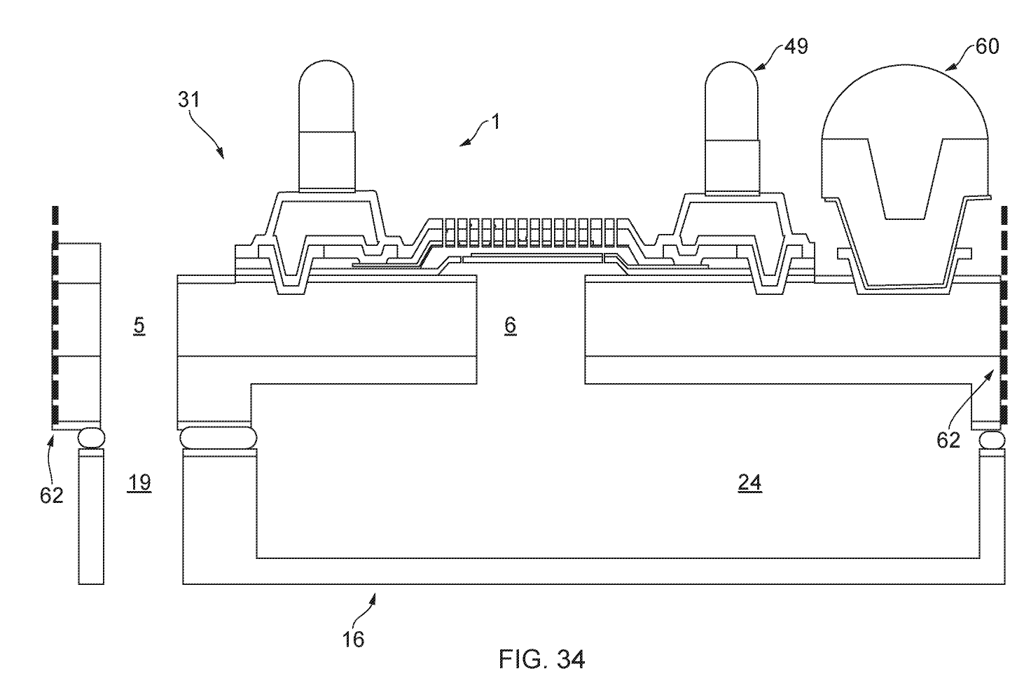

At this stage the die portion of the package may still comprise sacrificial layers 55a and 55b, as well as protective layer 2, which have served to protect surface features and components of the transducer element from mechanical or chemical damage or gathering debris or dust from other steps of the process. FIG. 34 shows the result of release etching 110 the protective layer 2, including the sacrificial layers 55. This etching opens up the acoustic die channel 5 to the outside environment. Thus both ends of the composite acoustic channel 5, 19 are now open to the outside environment to provide an acoustic pathway from the top face of the transducer package to the bottom face of the transducer package.

The capped transducer wafer 31 now contains multiple MEMS microphone transducers. All processing thus far has been implemented on all of the thousands of transducer die on the wafer in parallel with advantages discussed previously.

The capped MEMS transducer wafer 31 may now be singulated 112 into individual packages suitable for use along singulation lines 62, e.g. by stealth dicing, and MEMS transducer packages can be extracted. Prior to singulation the MEMS transducer wafer 31 may be mounted 111 on die attach film (DAF) for example, which may then be stretched to separate the die to assist in the extracting process 113, for instance a pick-and-place onto a tape-and-reel carrier.

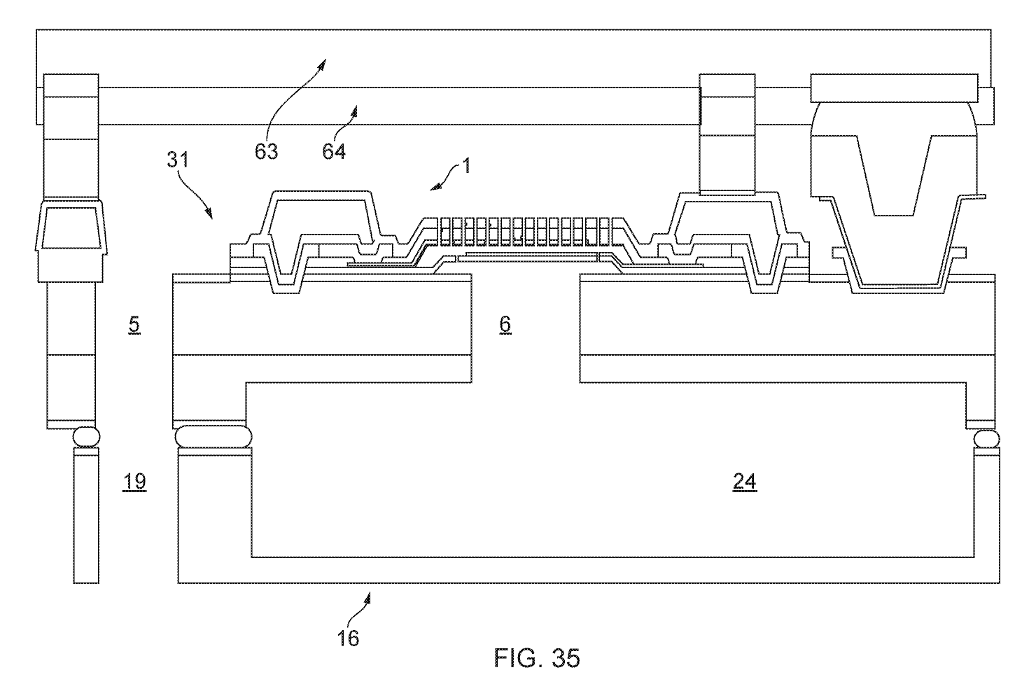

A MEMS microphone transducer package as obtained by the process described above may be used in top port configuration by operatively attaching it to a substrate 63, for instance a rigid or flexible printed circuit board (PCB), as shown in FIG. 35. The substrate 63 may be provided with another solder mask 64. Note for this end use case part of the seal structure 65 illustrated in FIG. 34 between the MEMS transducer element 56 and the acoustic channel 5 would be omitted and a similar structure added to the side of the acoustic channel so to produce the seal structure shown in FIG. 35.

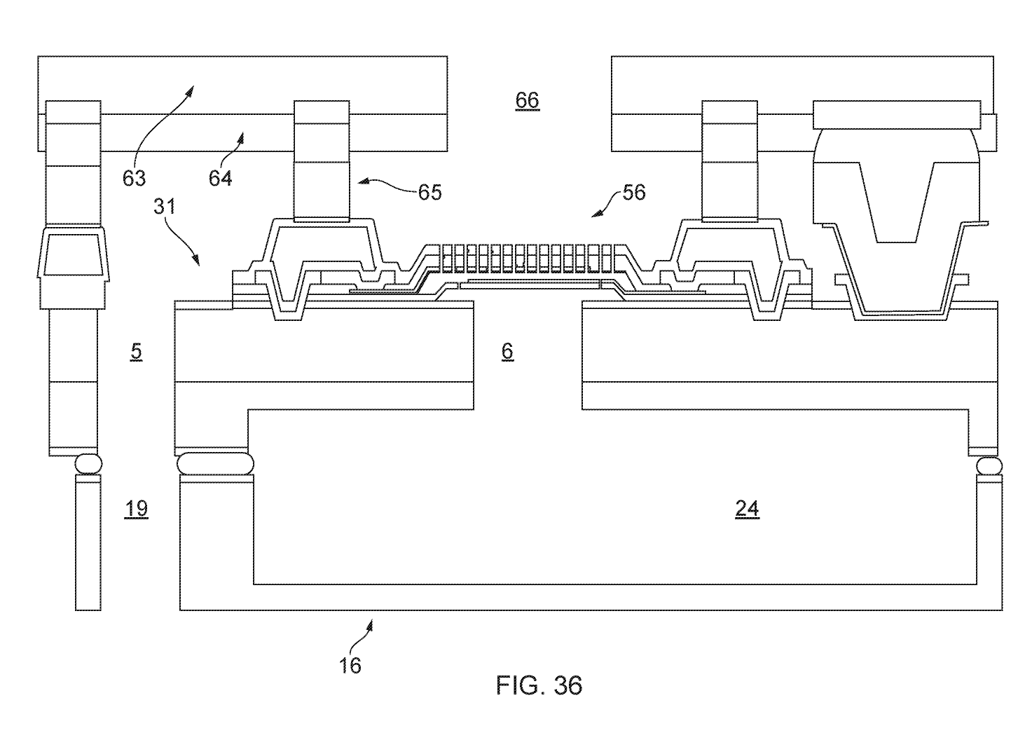

The MEMS microphone package may also be used in a bottom port configuration as shown in FIG. 36. The main difference is the presence of part of seal structure 65, which prevents the sound entering through the acoustic channel (5, 19) from reaching the transducer element 56. In the bottom port configuration sound reaches the transducer element 56 through a port 66 in the host substrate 63 attached to the package.

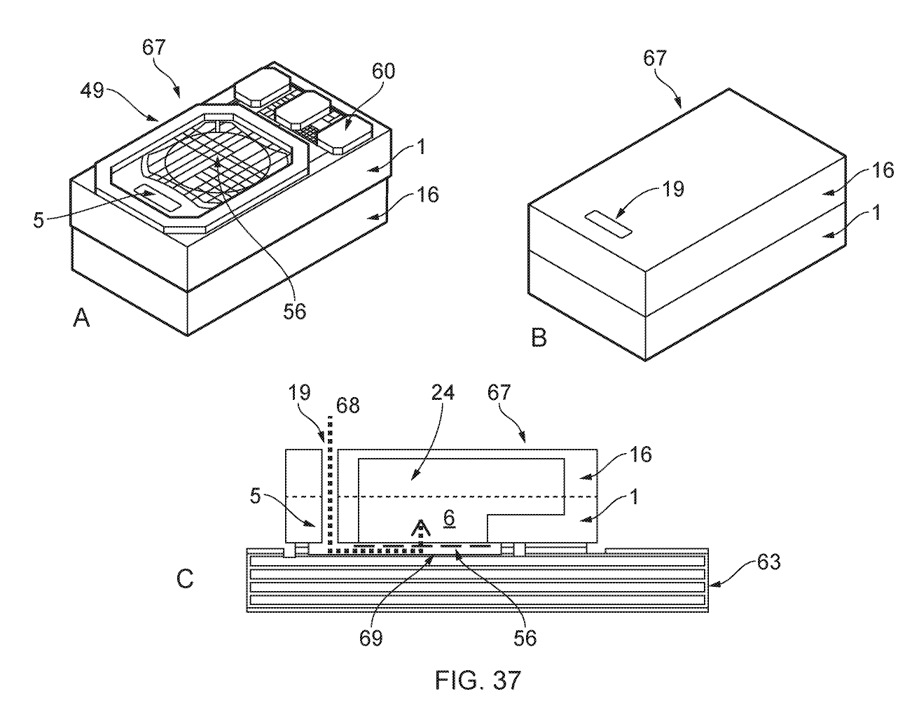

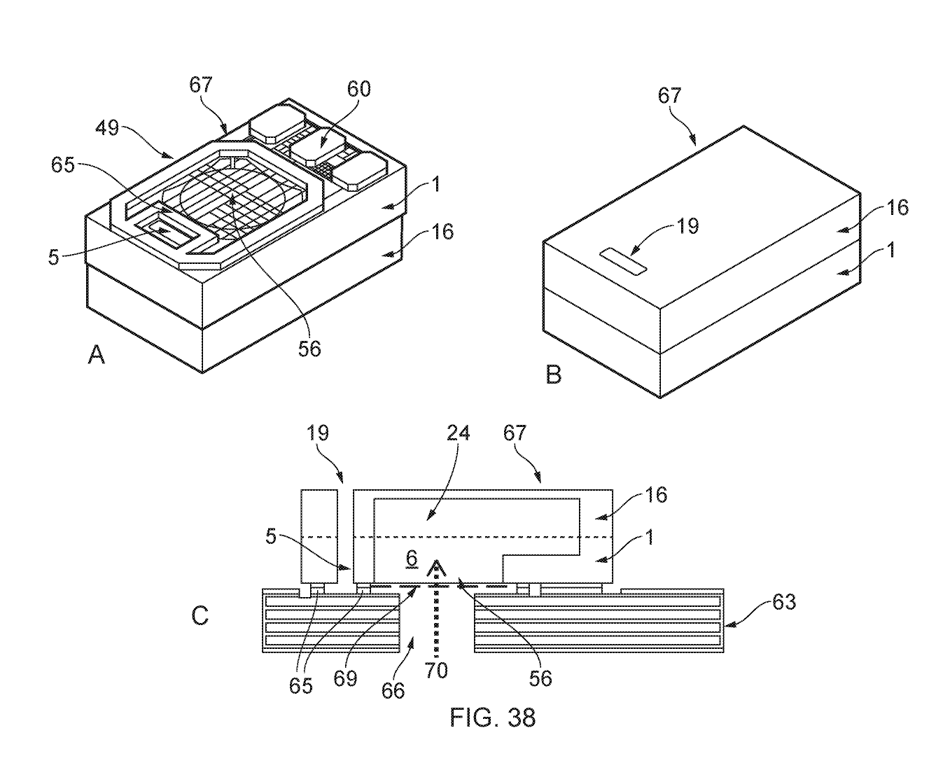

FIGS. 37 and 38, illustrate two embodiments of MEMS transducer packages 67 comprising a: cap wafer 16; die wafer 1; transducer element 56; bond pads 60; the outlet of acoustic die channel 5; and the inlet of acoustic cap channel 19. The main difference between the embodiments of FIGS. 37 and 38 is in the seal structure 49. As illustrated in FIG. 38, the seal structure 49 is marked by the absence of the part of the seal structure 65: added in the cross-section of FIG. 36. Accordingly, in FIG. 37A the seal structure 49 has a lay-out that encloses the transducer element 56 and the inlet of the acoustic die channel 5. Whereas in FIG. 38A the seal structure lay-out encloses the transducer element 56 and isolates the inlet of the acoustic die channel 5 from the transducer element 56.

FIGS. 37A and 38A show a view bottom view of the MEMS transducer; wherein the orientation is similar as e.g. in previous FIGS. 33 to 36. FIGS. 37B and 38B show a top view of the same MEMS transducer 67, from which no difference is apparent.

FIGS. 37C and 38C show a cross-section of two different configurations of mounting the MEMS transducer 37 on a substrate 63, in 37C in top port configuration and in FIG. 38C as bottom port configuration. The difference in mounting is facilitated by the difference in seal structure 49. FIGS. 37C and 38C both show how die back volume 6 of the die wafer 1 and the cap back volume 24 of the cap wafer 16 form a single MEMS transducer back volume. FIGS. 37C and 38C further show how acoustic die channel 5 and acoustic cap channel 19 form a single acoustic MEMS channel. In FIG. 37C it provides a sound path or acoustic pathway 68 running from the outside environment via a substrate volume 69 enclosed by the substrate 63, the MEMs transducer Package 67 and the seal structure 49 to the transducer element 56. However, in FIG. 38C the acoustic MEMS channel is sealed off, no sound entering the acoustic MEMS channel reaches the transducer element 56. Instead, port 66 in substrate 63 provides a sound path 70 running directly to the transducer element 56. Note FIGS. 36, 38A and 38C each illustrate a seal structure segment 65 on each side of the acoustic channel 5.

The embodiments of FIGS. 37 and 38 provide a vertical acoustic channel 5, 19 running from top face to bottom face of the package, and as illustrated show a die back volume stepped to avoid co-integrated circuitry, and a cuboid (un-stepped) cap back volume.

In order to provide the acoustic channel and back volume of the each individual die, during the step of wafer bonding 108 the die wafer 1 and the cap wafer 16 need to be aligned such that the acoustic die channel 5 and the acoustic cap channel 19 acoustically connect. And such that the die back volume 6 and the cap back volume 24 acoustically connect. FIG. 39 illustrates an enlarged part 80 of die wafer 1, which shows an acoustic layout 81 on several individual die 82 as contained by the die wafer 1. The layout 81 includes acoustic channel 5 and back volume 6 and illustrates the cross-sections which in this embodiment are rectangular. The wafer cap 16 accordingly is etched such that the etching of the acoustic cap channel 19 and the cap back volume 24 follows an acoustic layout that corresponds to the acoustic layout 81 which was used to etch the acoustic die channel 5 and the die back volume 6 of the semiconductor die wafer 1.

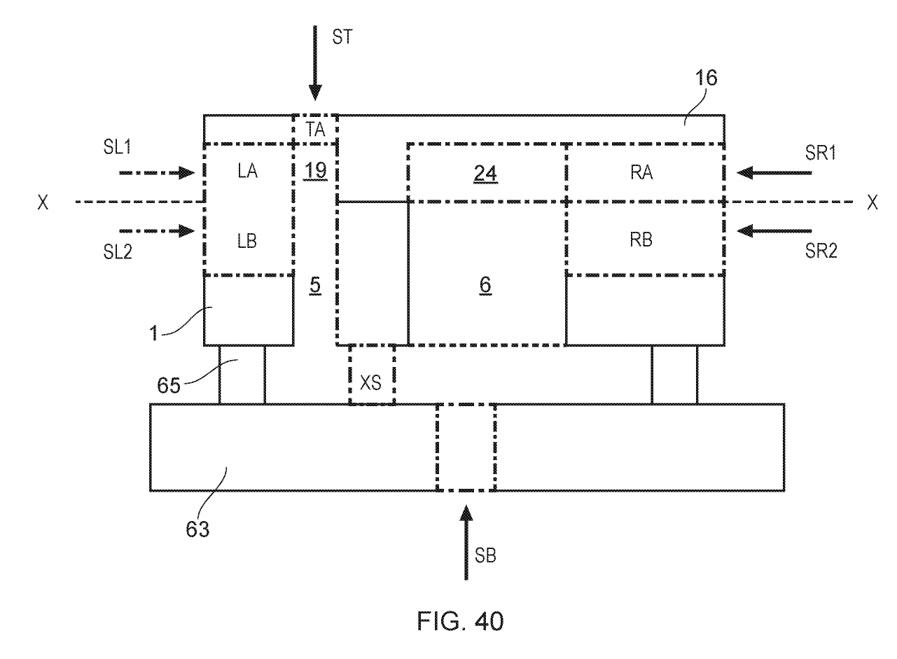

FIG. 40 illustrates the various options for sound to access the microphone transducer according to the chosen structure and dimensions of the acoustic channels and back volumes and underlying substrate. The die wafer acoustic channel 5 may have a lateral extension LB to allow sound SL2 from one side (arbitrarily considered the left side) to pass down the die wafer acoustic channel to the transducer element. Alternatively or additionally the wafer cap acoustic channel 19 may have a lateral extension to allow sound SL1 to enter from the same side. Alternatively or additionally the wafer cap acoustic channel may have an opening to the top of the package to allow sound ST from above to pass down the acoustic channel to the transducer element. The may be a part XS of the sealing structure 49 that unless absent will block any of these sound sources coupling though the acoustic channel.

Similarly the cap and/or die back volumes may have lateral extensions RA and RB to allow sounds SR1, SR2 to enter from the same side. These will access the transducer element from the other, upper, side, giving an inverted transducer output signal component. Thus if any other sources are coupled to the lower side of the transducer element, the net signal will represent the acoustic subtraction of the sounds.

The substrate may have an aperture to allow sound from underneath (SB) to access the transducer element. Again this sound may combine acoustically with sound passing via any other signal ports enabled by the structure.

Thus the same or very similar MEMS transducer package structures may be used in a wide variety of configurations.

In some embodiments the transducer package as disclosed herein provides only one useful acoustic port either at the top, bottom or a side face of the package.

In other embodiments contemplated herein, a plurality of ports, each on a different surface, i.e. top/bottom, and/or face, i.e. side, of the package are available for use. In some cases a plurality of ports communicate with the same side of the transducer element 56, and thus tend to add the respective signal components to provide an additive response.

In some cases of the plurality of ports communicate with opposite sides of the transducer element 56, and thus tend to subtract the respective signal components to provide a differential response.

The acoustic addition or subtraction of signals may be used in conjunction with appropriate external audio routing to the outside of a host apparatus to provide a directionality to the response, or for example to subtract appropriately filtered noise or interference components such as wind noise. Acoustic processing has the advantage of not requiring electrical power, in contrast to electronic processing and it may also prevent mechanical overload or consequent signal clipping of the transducer element.

In the embodiments described above it is noted that references to a transducer element may comprise various forms of transducer element. For example, a transducer element may comprise a single membrane and back-plate combination. In another example a transducer element comprises a plurality of individual transducers, for example multiple membrane/back-plate combinations. The individual transducers of a transducer element may be similar, or configured differently such that they respond to acoustic signals differently, e.g. the elements may have different sensitivities. A transducer element may also comprises different individual transducers positioned to receive acoustic signals from different acoustic channels.

It is noted that in the embodiments described herein a transducer element may comprise, for example, a microphone device comprising one or more membranes with electrodes for read-out/drive deposited on the membranes and/or a substrate or back-plate. In the case of MEMS pressure sensors and microphones, the electrical output signal may be obtained by measuring a signal related to the capacitance between the electrodes. However, it is noted that the embodiments are also intended to embrace the output signal being derived by monitoring piezo-resistive or piezo-electric elements or indeed a light source. The embodiments are also intended embrace a transducer element being a capacitive output transducer, wherein a membrane is moved by electrostatic forces generated by varying a potential difference applied across the electrodes, including examples of output transducers where piezo-electric elements are manufactured using MEMS techniques and stimulated to cause motion in flexible members.

It is also noted that one or more further portions may be added to an embodiment described above, i.e. in addition to the die portion and cap portion.

Such a portion, if present, may comprise an acoustic channel which cooperates with an acoustic channel(s) in the die portion and/or cap portion, to provide a desired sound port. For example, in an example where a die portion is provided to incorporate a transducer element, an integrated circuit portion to incorporate an integrated circuit, and a cap portion to form a cap, one or more of these portions may comprise acoustic channel(s) to provide a sound port as described herein.

It should be noted that the above-mentioned embodiments illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, “or” does not exclude “and”, and a single processor or other unit may fulfil the functions of several units recited in the claims. Any reference signs in the claims shall not be construed so as to limit their scope.

1. A method of fabricating a micro-electrical-mechanical system (MEMS) transducer chip scale package comprising:
providing a front side pre-fabricated semiconductor die wafer comprising a plurality of individual die that each comprise at least a MEMS transducer; and
back etching the semiconductor die wafer, wherein the back etching comprises:
at the back side of the semiconductor die wafer:
etching an acoustic die channel through each respective die of the plurality of die and etching a die back volume into each respective die of the plurality of die.

2. A method as claimed in claim 1, wherein back etching the semiconductor die wafer further comprises:
at the back side of the semiconductor die wafer:
semiconductor etching with a first depth the acoustic die channel with a first acoustic die channel cross-section and a die back volume with a first die back volume cross-section;
semiconductor etching with a second depth the acoustic die channel with a second acoustic die channel cross-section and the die back volume with a second die back volume cross-section; and
dielectric etching with a third depth the acoustic die channel with a third acoustic die channel cross-section and the die back volume with a third die back volume cross-section.

3. A method as claimed in claim 2, wherein:
the summed first depth and second depth span a thickness of a semiconductor portion of the semiconductor die wafer;
the first acoustic die channel cross-section, the second acoustic die channel cross-section, and the third acoustic die channel cross-section are the same; and
the first die back volume cross-section and the third die back volume cross-section correspond to a cross-section of a transducer element.

4. A method as claimed in claim 2, wherein:
the summed first depth and second depth span a thickness of a semiconductor portion of the semiconductor die wafer, and the second depth equals the first acoustic die channel cross-section;
the first acoustic die channel cross-section and the third acoustic die channel cross-section are the same;
the second acoustic die channel cross-section is such that the second acoustic die channel cross-section extends to a side of the semiconductor die wafer to form a side port; and
wherein the first die back volume cross-section and the third die back volume cross-section correspond to a cross-section of a transducer element.

5.-6. (canceled)

7. A method as claimed in claim 1, further comprising:
on the front of the semiconductor die:
forming a seal structure; and
forming a bump structure.

8. A method as claimed in claim 1, further comprising
providing a front side pre-fabricated wafer cap; and
wafer bonding the semiconductor die wafer and the front side pre-fabricated wafer cap thereby constituting a MEMS transducer wafer 31.

9.-12. (canceled)

13. A method as claimed in claim 8, wherein providing the front side pre-fabricated wafer cap comprises:
providing a wafer cap; and
at a front side of the wafer cap:
A) etching with a first depth an acoustic cap channel with a first cross-section; and/or
B) etching with a second depth the acoustic cap channel with a second cross-section; and/or
C) etching with a third depth a cap back volume with a first cross-section; and/or
D) etching with a fourth depth a cap back volume with a second cross-section.

14. A method as claimed in claim 13, wherein step A is performed and wherein the first depth of the acoustic cap channel is such that just a grind layer remains at a bottom of the acoustic cap channel, and wherein the first cross-section of the acoustic cap channel corresponds with the third cross-section of the acoustic die channel.

15. A method as claimed in claim 13, wherein step A is performed and wherein the first depth of the acoustic cap channel corresponds with the third cross-section of the acoustic die channel, and wherein the first cross-section of the acoustic cap channel is such that the acoustic cap channel extends to a side of the wafer cap to form a side port.

16. A method as claimed in claim 13, wherein step C is performed and wherein the third depth of the cap back volume ranges from ⅕ to ⅘ of a thickness of the wafer cap, and wherein the first cross-section of the cap back volume is at least equal or larger than the third cross-section of the die back volume.

17. A method as claimed in claim 13, wherein step A is performed, followed by performing steps B and C simultaneously, and wherein:
in step A the first depth of the acoustic cap channel determines a difference in depth of the acoustic cap channel and the cap back volume, and the first cross-section of the acoustic cap channel corresponds with the second cross-section of the acoustic cap channel; and
in step B the second depth of the acoustic cap channel is such that just a grind layer remains at a bottom of the acoustic cap channel, and the second cross-section of the acoustic cap channel corresponds with the third cross-section of the acoustic die channel; and
in step C the third depth of the cap back volume is the same as the second depth of the acoustic cap channel, and the first cross-section of the cap back volume is at least equal or larger than the third cross-section of the die back volume.

18. A method as claimed in claim 10, wherein step C is performed, followed by performing steps A and D simultaneously, and wherein:
in step C the third depth of the cap back volume determines a difference in depth of the cap back volume and the acoustic cap channel, and the first cross-section of the cap back volume is at least equal or larger than the second cross-section of the cap back volume; and
in step A the first depth of the acoustic cap channel corresponds with the third cross-section of the acoustic die channel, and the first cross-section of the acoustic cap channel is such that the acoustic cap channel extends to a side of the wafer cap; and
in step D the fourth depth of the cap back volume is the same as the first depth of the acoustic cap channel, and the second cross-section of the cap back volume is at least equal or larger than the third cross-section of the die back volume.

19. A method as claimed in claim 13, wherein the etching of the acoustic cap channel and the cap back volume follows an acoustic layout that corresponds to an acoustic layout used to etch the acoustic die channel and the die back volume of the semiconductor die wafer.

20. A method as claimed in claim 7, wherein the steps of forming the seal structure and of forming the bump structure are performed after the step of wafer bonding and prior to the step of back grinding the wafer cap.

21. (canceled)

22. A method as claimed in claim 7, wherein the steps of forming the seal structure and of forming the bump structure comprise:
etching a seal structure lay-out
etching a bump structure lay-out;
depositing a seed layer;
applying a solder mask;
applying plating;
applying solder; and
removing the solder mask and the seed layer.

23. A method as claimed in claim 22, wherein the seal structure lay-out encloses a transducer element and an inlet of the acoustic die channel.

24. A method as claimed in claim 22, wherein the seal structure lay-out encloses a transducer element and isolates an inlet of the acoustic die channel.

25. A method as claimed in claim 22, wherein etching the seal structure lay-out provides a bump of structurally enclosed protective layer material.

26. A method as claimed in claim 1, wherein the step of providing the front side pre-fabricated semiconductor die wafer comprises:
providing a semiconductor die wafer;
depositing a membrane and first electrode to a front side of the semiconductor die wafer;
depositing a back plate and second electrode to the front side of the semiconductor die wafer; and
forming acoustic holes in the back plate.

27. A method as claimed in claim 26, further comprising depositing one or more sacrificial layers during the step of providing the front side pre-fabricated semiconductor die wafer; and
wherein the one or more sacrificial layers form part of a protective layer.

28.-29. (canceled)
